(19) United States
(12) Patent Application Publication
(10) Pub. No.: US 2026/0145994 A1
(43) Pub. Date: May 28, 2026

(54) HIGH-STRENGTH, HIGHLY TRANSPARENT NANO-GLASS-CERAMIC, PREPARATION METHOD THEREFOR, AND USE THEREOF

(71) Applicant: HUNAN JINGCI NEW MATERIALS CO., LTD., Changsha (CN)

(72) Inventors: Yongbo HU, Changsha (CN); Bin WANG, Changsha (CN)

(73) Assignee: HUNAN JINGCI NEW MATERIALS CO., LTD., Changsha (CN)

(21) Appl. No.: 19/447,963

(22) Filed: Jan. 13, 2026

Related U.S. Application Data
(63) Continuation of application No. PCT/CN2023/143160, filed on Dec. 29, 2023.

(51) Int. Cl. C03C 10/00

(52) U.S. Cl. CPC C03C 10/0027; C03C 2203/10; C03C 2204/00

(57) ABSTRACT

A high-strength, highly transparent nano-glass-ceramic, a preparation method therefor, and a use thereof. The high-strength, highly transparent nano-glass-ceramic uses precursor minerals mainly comprising synthetic aluminum-rich feldspar-like ceramic glass material, β-spodumene material, cordierite material, synthetic β-dicalcium silicate material, and magnesium aluminum spinel material for the main body of a feldspar-like matrix glass having a stable structure. Ultrafine zirconia powder having a particle size of less than 10 nm is used as a nucleating agent and microcrack damping and pinning agent, to control the formation of nanocrystallites smaller than 100 nm in the glass body formed after melting. The volume percentage content of the nanocrystallites is 50%-95%, and the nanocrystallites together with the matrix glass form a high-strength, highly transparent nano-glass-ceramic having a uniform microstructure.

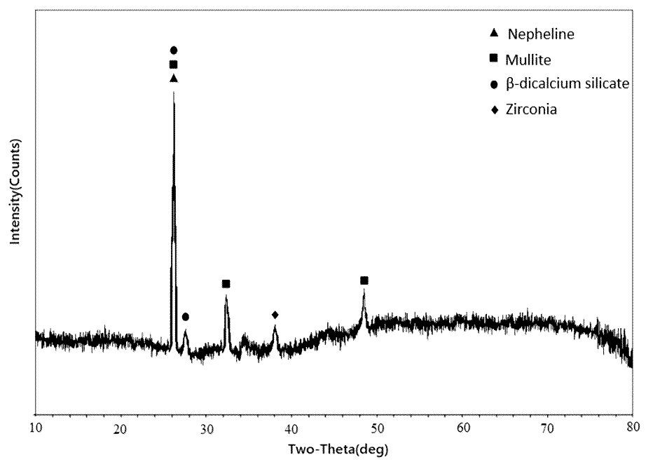

### CROSS-REFERENCE TO RELATED APPLICATIONS

This application is a continuation of International Application No. PCT/CN2023/143160, filed on Dec. 29, 2023, the content of which is incorporated herein by reference in its entirety.

### TECHNICAL FIELD

The present disclosure belongs to the technical field of materials, and relates to high-strength highly transparent nano-glass-ceramic and a preparation method therefor and application thereof.

### BACKGROUND

As the application scope of smartphones continues to expand, the performance requirements for the smartphones are also increasing, especially in terms of panel hardness, strength, fracture toughness, light transmittance, corrosion resistance, etc. of cell phones. For example, cover or back cover glass for an electronic device such as a 5G cell phone itself must not only have good light transmittance of optical glass, i.e., light transmittance ≥90%, but also have relatively high fracture toughness strength and surface hardness and corrosion resistance. However, at present, touch panel glass widely used in displays of a cell phone and other palm computers has low surface hardness, is easily worn, and is easily scratched, and has poor fracture toughness. When the cell phone falls from a position with a height of less than 1 m, a panel cracks, and the drop resistance is insufficient, affecting normal use; and the surface is poor in corrosion resistance, and when the cell phone is often held in a hand, the panel is easily eroded by sweat, resulting in a hairy or foggy appearance, which affects the light transmittance and the beauty.

### SUMMARY

The technical problem to be solved by the present disclosure is to provide high-strength highly transparent nano-glass-ceramic, a preparation method therefor and application thereof in view of the above deficiencies of glass materials in the prior art. The manufactured nano-glass-ceramic is high in light transmittance, high in mechanical strength, high in surface hardness, high in fracture toughness, good in corrosion resistance, and small in thermal expansion coefficient, and the light transmittance is 90% or more; and the nano-glass-ceramic can be widely used to manufacture optical glass, including cell phone covers or back covers, cover glass for high-end electronic products, and windshield and side window glass for high-speed trains and aviation aircraft, viewing window glass for high-end instruments and equipment, and the like.

The technical solutions adopted to solve the technical problem of the present disclosure are as follows.

In a first aspect, the present disclosure provides high-strength highly transparent nano-glass-ceramic, employing precursor mineral materials including a synthetic aluminum-rich feldspar type ceramic glass material, a β-spodumene or β-spodumene solid solution material, a cordierite material, a synthetic β-dicalcium silicate material, i.e., synthetic β-Ca₂SiO₄, and a magnesia-alumina spinel material as a main body of feldspar type matrix glass with a stable structure, wherein zirconia micropowder having a particle size of less than 10 nm (or yttria-stabilized zirconia micropowder, e.g., zirconia micropowder of 3-10 nm or yttria-stabilized zirconia micropowder of 3-10 nm) is used as a nucleating agent and a microcrack damping pinning agent to control the formation of nanocrystallites of less than 100 nm in a glass body formed after melting, the nanocrystallites being present in an amount of 50-95% by volume, and being intergrown with the matrix glass to form high-strength highly transparent nano-glass-ceramic with a uniform microstructure.

The synthetic aluminum-rich feldspar type ceramic glass material refers to a ceramic glass material made of synthetic aluminum-rich feldspar minerals, and the feldspar minerals in the present disclosure refer to a collective name for orthoclase, plagioclase (also divided into albite, oligoclase, andesine, labradorite, bytownite, and anorthite), and their feldspar-like minerals and various variants (e.g., orthoclase variants such as sanidine, microcline, etc.). The feldspar-like minerals include analcime, cancrinite, leucite, nepheline, pollucite, scapolite, marialite, meionite and sodalite, which are all alkali-containing aluminosilicate minerals. The aluminum-rich feldspar minerals refer to minerals such as anorthite, celsian, and lithium feldspar, having a content of alumina (Al₂O₃) exceeding that of normal albite, including that in order to increase the content of alumina (Al₂O₃) in feldspar minerals, a value of X is 1.1≤X≤2.4 and a value of Y is 2≤Y≤6 in K₂O/Na₂O/Li₂O/CaO/BaOXAl₂O₃YSiO₂ by synthesis (it is possible to make the content of silica lower than the normal content in feldspar minerals), and even if the content of alumina (Al₂O₃) exceeds that of the normal albite mineral, the aluminum-rich feldspar minerals becomes synthetic aluminum-rich feldspar minerals.

Controlling the formation of nanocrystallites of less than 100 nm in the glass body formed after melting, the nanocrystallites being present in an amount of 50-95% by mass, is mainly achieved by adding the zirconia micropowder of less than 10 nm (or yttria-stabilized zirconia micropowder of 3-10 nm) as the nucleating agent, while tightly controlling the nucleation temperature and time, and the crystallization temperature and time of glass-ceramic to obtain nanocrystallites with a desired grain fineness and amount.

Preferably, a chemical formula of the synthetic aluminum-rich feldspar type ceramic glass material is K₂O/Na₂O/Li₂O/CaO/BaOXAl₂O₃YSiO₂, wherein 1.1≤X≤2.4, and Y=2-6, and the synthetic aluminum-rich feldspar type ceramic glass material is expressed as a composite ceramic glass material of one or two or more of a plurality of synthetic aluminum-rich feldspars of synthetic aluminum-rich potassium feldspar, synthetic aluminum-rich albite, synthetic aluminum-rich lithium feldspar, synthetic aluminum-rich anorthite, and synthetic aluminum-rich celsian, and
wherein the composite ceramic glass material of two or more of the plurality of synthetic aluminum-rich feldspars at least includes a composite ceramic glass material of the synthetic aluminum-rich albite.

Preferably, the synthetic β-dicalcium silicate material is a stable synthetic β-dicalcium silicate material, i.e., O—Ca₂SiO₄ or β-2CaO·SiO₂ obtained by determining the amount of limestone or calcite or calcium oxide and quartz used in synthetic raw materials according to a theoretical weight ratio of CaO to SiO₂ in a molecular formula CaOSiO₂ of wollastonite, uniformly mixing the two raw materials, performing firing at a firing temperature of 1320-1360° C. to obtain synthetic wollastonite, i.e., CaSiO₃, grinding the synthetic CaSiO₃ and a mineralizer B₂O₃ with an amount being 0.5-1.5% of the moles of CaSiO₃ together into a powder, and performing firing at 1280-1320° C.

Preferably, the high-strength highly transparent nano-glass-ceramic uses mineral raw materials as the main body, and further includes quartz powder, and a fining agent for glass melting, and includes the following raw material components in percentage by mass:
54-80% a synthetic aluminum-rich feldspar type ceramic glass material;
3-30% a β-spodumene material or a β-spodumene solid solution;
1-6% a cordierite material;
5-20% synthetic β-dicalcium silicate;
2-10% a magnesia-alumina spinel material;
1-6% zirconia micropowder having a particle size of less than 10 nm;
5-20% high-purity quartz powder; and
0.5-2% a fining agent for glass melting.

Wherein the synthetic β-dicalcium silicate is β-2CaO·SiO₂ (β-Ca₂SiO₄), and β-Ca₂SiO₄ is a toughening agent that can improve the toughness strength and overcome the brittleness of the nano-glass-ceramic.

Preferably, a chemical composition of the high-strength highly transparent nano-glass-ceramic includes in percentage by mass:
6-14% K₂O+Na₂O+BaO;
0.2-3% Li₂O;
20-36% Al₂O₃;
40-69% SiO₂;
2-10% CaO;
1-6% ZrO₂; and
2-10% MgO.

Further preferably, according to the chemical formula R₂O/ROXAl₂O₃YSiO₂ of the synthetic aluminum-rich feldspar type ceramic glass material, wherein 1.1≤X≤2.4, and Y=2-6, Y≤6 when R₂O is K₂O/Na₂O/Li₂O, Y>2 when RO is CaO/BaO, and Y=2-6 when having feldspars corresponding to R₂O/RO at the same time. The corresponding potassium/sodium/lithium/calcium/barium feldspar refined raw materials (with an iron content of less than 10 ppm after iron removal and impurity removal), and added alumina powder of which the amount is equivalent to 10-140% of the Al₂O₃ content in feldspar raw materials are used in proportion to be prepared into a batch, the batch is pulverized and ground uniformly to 300-1000 meshes, and calcination thermal synthesis is performed; or corresponding potassium/sodium/lithium/calcium/barium carbonate chemical raw materials, alumina powder of 300-1000 meshes of which the amount is equivalent to 110-240% of the Al₂O₃ content in feldspar raw materials, and high-purity quartz powder of 300-1000 meshes are used in proportion to be prepared into a batch, the batch is stirred uniformly, and calcination thermal synthesis is performed to obtain the synthetic aluminum-rich feldspar type ceramic glass material.

Preferably, when the synthetic aluminum-rich feldspar type ceramic glass material contains both K₂O and Li₂O, the content of K₂O+Li₂O is 2-6% (in the synthetic aluminum-rich feldspar type ceramic glass material), and K₂O:Li₂O=4-5:1 or 1:4-5, forming a mixed alkali effect, which is beneficial for reducing the melting temperature and improving the chemical stability.

Preferably, when the synthetic aluminum-rich feldspar type ceramic glass material is a sodium nepheline aluminum-rich feldspar type ceramic glass material of Na₂OXAl₂O₃2SiO₂, in order to improve the strength, the raw materials further include 0.2-0.5% rare earth or rare metal oxides that are non-coloring in the glass, such as oxides of metals such as niobium, scandium, gallium, lanthanum, yttrium, and hafnium.

Preferably, the raw materials used further include yttria Y₂O₃ as a stabilizer for zirconia ultrafine powder in an amount of zirconia:yttria=90-95:5-10, or yttria-stabilized zirconia raw material micropowder (having the same ratio of zirconia:yttria=90-95:5-10) is used directly instead of the zirconia micropowder. When the yttria-stabilized zirconia returns to a low temperature state such as room temperature after a high temperature (1173° C. or more), a stable phase of zirconia remains tetragonal and does not undergo crystal phase transformation, so that the volume is stabilized. The yttria-stabilized zirconia raw materials are commercially available raw materials. To prevent agglomeration of the zirconia micropowder having a particle size of less than 10 nm or yttria-stabilized zirconia raw materials of 3-10 nm, a graphene oxide dispersant is added in a ratio of zirconia to the graphene oxide dispersant being 1:3 (i.e., the amount of the graphene oxide dispersant is 3 times the amount of zirconia), ball milling is performed, and the ball-milled material is then added to a glass batch to be ball-milled together, so that the zirconia micropowder of less than 10 nm can be dispersed and uniformly distributed in the glass batch without agglomeration.

Preferably, the raw materials used also include 0-5% by mass a network-enhancing raw material boron phosphate BO₄P, so that a P₂O₅ component can be introduced. Boron phosphate BO₄P can use a commercially available raw material.

Preferably, the raw materials also include phosphates: the phosphates used are calcium zirconium phosphate CaZr(PO₄)₂ and calcium phosphate Ca₃(PO₄)₂, the content of CaZr(PO₄)₂+Ca₃(PO₄)₂ being 0-5%, CaZr(PO₄)₂:Ca₃(PO₄)₂=5:1-2:1, thereby improving stability and strength.

Preferably, the β-spodumene raw material or the β-spodumene solid solution is synthesized by sintering at a firing temperature of 1300-1390° C. by using LiCO₃ as a Li₂O source, alumina powder as an alumina source and high-purity quartz powder as a SiO₂ source in precursor raw materials according to a theoretical mass ratio of Li₂O to Al₂O₃ to SiO₂ in a chemical formula Li₂OAl₂O₃nSiO₂ of β-spodumene, where n=4-8 (0-spodumene when n=4, and the β-spodumene solid solution when 4<n≤8), or β-spodumene is directly obtained by calcining spodumene concentrate powder at 1300° C.; and
the cordierite material is synthesized by sintering at 1300-1400° C. by using talc concentrate powder or a MgO analytically pure chemical raw material as a MgO source, alumina powder as an alumina source, and high-purity quartz powder as a SiO₂ source in precursor raw materials according to a theoretical mass ratio of MgO to Al₂O₃ to SiO₂ in a chemical formula 2MgO2Al₂O₃5SiO₂ of cordierite.

Preferably, the nanocrystallites include aluminum-rich feldspar-type nanocrystallites, 3-spodumene nanocrystallites or β-spodumene solid solution nanocrystallites, cordierite nanocrystallites, β-dicalcium silicate nanocrystallites, magnesia-alumina spinel nanocrystallites, mullite nanocrystallites (an aluminum-rich part forms mullite with part of SiO₂ and quartz in the corresponding feldspar), zirconia nanocrystallites or zirconia/yttria solid solution nanocrystallites (with yttria Y₂O₃ as a stabilizer).

Further preferably, the contents by volume of the respective nanocrystallites in the total nanocrystallites are as follows:
Aluminum-rich feldspar type nanocrystallites, i.e., K₂O/Na₂O/Li₂O/CaO/BaOXAl₂O₃YSiO₂ nanocrystallites, where 1.1≤X≤2.4, and Y=2-6 50-80%;
β-spodumene nanocrystallites or β-spodumene solid solution nanocrystallites, i.e., β-Li₂OAl₂O₃nSiO₂ nanocrystallites 3-28%;
Cordierite nanocrystallites, i.e., 2MgO2Al₂O₃5SiO₂ nanocrystallites 1-6%;
Synthetic β-dicalcium silicate nanocrystallites, i.e., P-2CaO·SiO₂ nanocrystallites 5-20%;
Magnesia-alumina spinel nanocrystallites 2-10%;
Mullite nanocrystallites 5-20%; and
Zirconia nanocrystallites or zirconia/yttria solid solution nanocrystallites 1-6%.

Further included are 0.5-2% diopside nanocrystallites (formed from aluminum rich and β-dicalcium silicate), and the magnesia-alumina spinel nanocrystallites includes composite magnesia-alumina spinel nanocrystallites such as ROMgOAl₂O₃ spinel nanocrystallites, RO being CaO and/or BaO, or the like.

The aluminum-rich feldspar type nanocrystallites are a main crystal phase of the nano-glass-ceramic, and provide a basis for high strength of the nano-glass-ceramic endowed by the action of a framework of the feldspar type matrix glass with high strength, and the amount of the aluminum-rich feldspar type nanocrystallites accounts for 50% or more of the total amount of microcrystallites, and the aluminum-rich feldspar type nanocrystallites exhibit continuous compositional continuity with the residual glass phase, and the refractive index is close to the same, so that the nano-glass-ceramic has high light transmittance in a visible region; the β-spodumene nanocrystallites or β-spodumene solid solution nanocrystallites and the cordierite nanocrystallites in the nano-glass-ceramic have dual effects of reducing the thermal expansion coefficient of the glass-ceramic, improving thermal stability and thermal shock resistance; the synthetic β-dicalcium silicate nanocrystallites are ring-shaped microcrystallites combined with aluminum-rich feldspar type nanocrystallites to form interlocking, producing synergistic actions and effects, and greatly increasing the fracture toughness of the nano-glass-ceramic, and strengthening the surface hardness of the aluminum-rich feldspar type nanocrystallites; the magnesia-alumina spinel nanocrystallites are good in thermal shock resistance, and high in high-temperature compressive strength; and the mullite nanocrystallites improve the hardness and impact strength of the nano-glass-ceramic, and have good thermal shock resistance and high chemical stability, and the zirconia or zirconia/yttria solid solution nanocrystallites can increase toughness, can pin and rivet glass microcracks between glass and a grain boundary and thus prevent expansion of the glass microcracks, and at the same time have toughening effects on β-dicalcium silicate nanocrystallites, and both have synergistic actions and effects.

The aluminum-rich feldspar type nanocrystallites include one or two or more mixed nanocrystallites of aluminum-rich potassium feldspar nanocrystallites, aluminum-rich albite nanocrystallites, aluminum-rich lithium feldspar nanocrystallites, aluminum-rich anorthite nanocrystallites, and aluminum-rich celsian nanocrystallites, forming a framework-like long-chain structure in the nano-glass-ceramic, and the synthetic β-dicalcium silicate nanocrystallites p-2CaO·SiO₂ are of ring buckles with a ring structure, so that one or more long-chain structured aluminum-rich feldspar type nanocrystallites are surrounded and buckled by the β-dicalcium silicate nanocrystallites to form locked crystals, and the locked crystals are also surrounded and buckled by the β-2CaO·SiO₂ nanocrystallites through the long-chain structured aluminum-rich feldspar type nanocrystallites to form a three-dimensional locked crystal space structure, reinforcing the framework-like main crystal phase, and the zirconia nanocrystallites or zirconia/yttria solid solution nanocrystallites pin and rivet glass microcracks, greatly improving the fracture toughness.

Preferably, the content of K₂O+Na₂O+BaO is 6-14%, wherein:
when the aluminum-rich feldspar type nanocrystallites are mainly aluminum-rich potassium feldspar nanocrystallites,
the content of K₂O is 4%-9%, the content of Na₂O is 2%-7%, and the content of BaO is 0-2%;
when the aluminum-rich feldspar type nanocrystallites are mainly aluminum-rich albite nanocrystallites,
the content of K₂O is 0.85%-4%, the content of Na₂O is 6%-12%, and the content of BaO is 0%-1%;
when the aluminum-rich feldspar type nanocrystallites contain aluminum-rich celsian nanocrystallites,
the content of BaO is 2%-6%, the content of K₂O is 0.85%-2%, and the content of Na₂O is 6%-10%;
further preferably, when the above aluminum-rich feldspar type nanocrystallites further contain aluminum-rich lithium feldspar nanocrystallites,
the content of Li₂O is 2%-5%, the content of Na₂O is 6%-9%, the content of K₂O is 0.85%-3%, and the content of BaO is 0%-2%; and
when the above aluminum-rich feldspar type nanocrystallites further contain aluminum-rich anorthite nanocrystallites,
the content of CaO is 2%-5%, the content of Na₂O is 6%-9%, the content of K₂G is 0.85%-3%, and the content of BaO is 0-2%.

Preferably, the magnesia-alumina spinel raw material includes synthetic composite magnesia-alumina spinel.

Further preferably, the synthetic composite magnesia-alumina spinel includes different metal oxides in addition to magnesia-alumina spinel, the different metal oxides and alumina respectively form composite spinel crystal structures at a synthesis temperature, the different metal oxides include calcium oxide and barium oxide, and calcium aluminate spinel and barium aluminate spinel, and one or two or more of these spinels can be respectively formed, including at least composite magnesia-alumina spinel formed by compounding the barium aluminate spinel (the barium aluminate spinel is advantageous to reduce the synthesis temperature of spinel formation, reducing the synthesis temperature to 1260-1360° C.) with the magnesia-alumina spinel.

A raw material used for the fining agent for glass melting is Sb₂O₅ as a fining agent.

Preferably, the high-strength highly transparent nano-glass-ceramic is subjected to primary or secondary chemical strengthening. The Mohs hardness is 6.0-8.0 before strengthening, and is 7.0-9.0 after strengthening, the fracture toughness is 4.8-8 MPa·m^{1/2} before strengthening, and is 10-12 MPa·m^{1/2} after strengthening, the light transmittance is 91%-96%, and the ring-on-ring strength is 3200 MPa after strengthening for a glass sheet with a thickness of 0.4 mm, and is 5600 MPa after strengthening for a glass sheet with a thickness of 0.6 mm, that is, the ring-on-ring strength is 3200-5600 MPa after strengthening.

According to a second aspect of the present disclosure, provided is a method for preparing high-strength highly transparent nano-glass-ceramic, including:
preparation of synthetic raw materials: carrying out synthesis according to the proportion of synthetic raw materials in the high-strength highly transparent nano-glass-ceramic to obtain corresponding synthetic mineral materials;
formula batching: batching the synthetic raw materials with other raw materials according to the formula ratio requirements;
processing and mixing: pulverizing raw materials of a batch to a desired fineness such as 200-300 meshes, and uniformly mixing the pulverized materials to obtain a dry powder glass raw batch;
melt forming: adding the dry powder batch into a glass melting device, performing melting, fining, and homogenizing, and performing forming by adopting an appropriate forming method according to the product requirements;
nucleation and crystallization: nucleating the formed glass product at a nucleation temperature, and then performing crystallization by controlling the temperature and time to control the growth of grains into nanocrystallites with a desired fineness and amount; and
annealing: annealing the crystallized product to eliminate a thermal stress in a glass body to obtain a high-strength highly transparent nano-glass-ceramic product.

Preferably, the method further includes performing further forming and processing on the nano-glass-ceramic product to obtain a desired structure, followed by strengthening treatment.

Further preferably, strengthening the nano-glass-ceramic product includes physical strengthening or chemical strengthening.

The chemical strengthening is once chemical strengthening or twice chemical strengthening, and a surface compressive stress layer generated by ion exchange after strengthening has a depth of 20-120 m. For example, a surface compressive stress layer after chemical strengthening of thin transparent nano-glass-ceramic with a thickness of 0.4-0.6 mm has a depth of 120 μm.

The twice chemical strengthening is twice staged ion exchange strengthening in such a way that primary strengthening is Na⁺→Li⁺ (replacing lithium ions with sodium ions and holding in a molten salt solution at 380-420° C. for 6-10 hours), and secondary strengthening is K⁺→Na⁺ (replacing sodium ions with potassium ions and holding in a molten salt solution at 470-500° C. for 8-15 hours), thereby greatly improving the mechanical strength of the glass-ceramic.

The synthetic raw materials as described above include a synthetic aluminum-rich feldspar type glass ceramic material, synthetic β-dicalcium silicate, a synthetic (composite) magnesia-alumina spinel material, synthetic cordierite, or synthetic β-spodumene or β-spodumene solid solution (if desired).

Preferably, adding the dry powder batch into the glass melting device during the melt forming includes adding the dry powder batch to a sagger for melting glass (i.e., the nano-glass-ceramic is produced by using a sagger in-situ growth method, the sagger is charged with the dry powder batch to produce glass in an oxidizing atmosphere or an oxidizing-reducing atmosphere, and colored nano-glass-ceramic for back panels is produced in the oxidizing-reducing atmosphere), and placing the sagger in a high temperature furnace for melting, fining, and homogenizing in the oxidizing atmosphere or the oxidizing-reducing atmosphere. The thermal expansion coefficient of the sagger used should be basically consistent with that of the matrix glass.

Further preferably, the sagger is a magnesia-alumina spinel sagger or an a-corundum-mullite sagger or an a-corundum-quartz glass sagger.

Further preferably, the magnesia-alumina spinel sagger is a synthetic composite magnesia-alumina spinel sagger.

Preferably, the nucleation and crystallization adopt an in-situ growth method, i.e., the glass is formed directly through the shape of the sagger, and the glass in the sagger together with the sagger is directly nucleated and crystallized in a kiln, and then annealed to obtain the transparent nano-glass-ceramic.

Further preferably, the transparent nano-glass-ceramic obtained through nucleation and crystallization by the in-situ growth method is segmented from the sagger, then subjected to further forming and processing to obtain a desired structure, and then subjected to strengthening treatment.

Cut sagger waste and glass-ceramic waste are recycled as secondary materials.

Preferably, during the melt forming, melting includes adding the dry powder batch into a furnace for melting glass for melting, fining, and homogenizing, and forming is carried out by tape casting, or calendering, or overflow forming.

Preferably, the melting temperature is 1500-1600° C., and the fining temperature is 1550-1600° C. That is, the melting and fining include heating the dry powder batch to a temperature of 1500-1600° C., and performing melting for 2-8 hours, and performing fining at a temperature of 1550-1600° C. for 2-6 hours.

Preferably, the nucleation and crystallization include: performing nucleation at a temperature of 600-650° C. for 2-4 h, and performing crystallization at a temperature of 650-750° C. for 2-6 h. Here, the temperature and time of nucleation and crystallization are strictly controlled so that the fineness of nanocrystallites can be controlled to be 100 nm or below, most of the nanocrystallites are 10-30 nm, and the amount of the nanocrystallites is 50-95%.

Preferably, the annealing is performed at a temperature of 500-550° C., a heating rate is not more than 0.5° C./min, the holding time during annealing is 1-4 h, and cooling is performed from the holding temperature during annealing to room temperature at a cooling rate of 0.2-0.4° C./min.

Preferably, before the nucleation and crystallization, the formed glass product is first pre-annealed, and a pre-annealing process includes first heating the glass product to 650-750° C., performing heat preservation for 2-5 h, then reducing the temperature to 550-600° C. at 0.2-0.3° C./min, performing the pre-annealing while maintaining the temperature for 2-3 h, then reducing the temperature to 500° C. at 0.2-0.3° C./min, performing heat preservation for 2-3 h, and then raising the temperature to the nucleation temperature at no more than 0.5° C./min for the subsequent nucleation and crystallization and annealing.

According to a third aspect of the present disclosure, provided is application of high-strength highly transparent nano-glass-ceramic, where the high-strength highly transparent nano-glass-ceramic is applied to manufacture various types of optical glass, including cell phone covers and back covers, cameras, cover glass for high-end electronic products, windshield and side window glass for high-speed trains and aviation aircraft, viewing window glass for high-end instruments and equipment, vehicle-mounted control panels, quantum radar panels, and the like.

The high-strength highly transparent nano-glass-ceramic of the present disclosure achieves the following technical performance indexes: a drop resistance test at a specified height: a glass sheet with a length and a width of 5×5 cm and a thickness of 0.5 mm is not broken when vertically dropped from a height of 2.5 meters, the fracture toughness is 5-8 MPa·m^{1/2} before strengthening, and is 10-12 MPa·m^{1/2} after strengthening, hardness: the Mohs hardness is 7-8 before strengthening, and is 8-9 after strengthening, and optical properties: 1. refractive index: 1.51-1.53; 2. 90%<visible light transmittance<95%; and 3. haze: <0.1%. Mechanical properties include: 1. a Poisson's ratio of 0.21-0.23; 2. a Young's modulus of 11.5-14.1 Mpsi after strengthening; 3. Vickers hardness of 660 kgf/mm² or more before strengthening, and Vickers hardness of 780 kgf/mm² or more after strengthening; 4. flexural strength of more than 550 MPa before strengthening, and flexural strength of more than 800 Mpa after strengthening, and ring-on-ring strength of 3200-5000 Mpa after strengthening (a glass sheet has a thickness of 0.4-0.6 mm).

### BRIEF DESCRIPTION OF THE DRAWINGS

The accompanying FIGURE is an X-ray diffraction pattern of nano-glass-ceramic in Preparation example 15 in Table 3 in Example 1.

### DETAILED DESCRIPTION OF THE EMBODIMENTS

In order to further elucidate the technical means adopted by the present disclosure and the effects thereof, the following detailed description is made in conjunction with the preferred examples of the present disclosure and the accompanying drawings.

The technical solutions in the examples of the present disclosure will be clearly and completely described below in conjunction with the examples of the present disclosure. Obviously, the described examples are only some of the examples of the present disclosure, rather than all of the examples. Based on the examples in the present disclosure, all other examples obtained by those skilled in the art without inventive step belong to the scope of protection of the present disclosure.

In the description of the present disclosure, it is to be understood that the terms “first” and “second” are used for descriptive purposes only and cannot be understood to indicate or imply relative importance or to implicitly indicate the number of technical features indicated. Thus, features defined by “first” and “second” may explicitly or implicitly include one or more features. In the description of the present disclosure, “a plurality of” means two or more, unless expressly and specifically defined otherwise.

In the present disclosure, the word “exemplary” is used to mean “serving as an example, instance, or illustration.” Any example described as “exemplary” in the present disclosure is not necessarily to be construed as preferred or advantageous over other examples. In order to enable any person skilled in the art to implement and use the present disclosure, the following description is given. In the following description, details are set forth for the purpose of explanation. It should be understood that those of ordinary skill in the art may recognize that the present disclosure may be implemented without the use of these specific details. In other instances, well-known structures and processes are not described in detail in order to avoid obscuring the description of the present disclosure with unnecessary details. Thus, the present disclosure is not intended to be limited to the examples shown, but is consistent with the widest scope of the principles and features disclosed in the present disclosure.

In order to manufacture glass-ceramic with high strength, good light transmittance and high chemical stability, a matrix glass system with high strength is selected first. The present disclosure uses feldspar type mineral raw materials with high Al₂O₃ content as the matrix glass system. Feldspar matrix glass melted at 1500-1600° C. is transparent itself, and has high strength and high hardness, mainly because the feldspar contains high Al₂O₃ content. The glass-ceramic is a solid, dense and uniform composite material composed of crystal phases and glass manufactured by microcrystallization on the basis of matrix glass, and is also known as ceramic glass. Obviously, if glass-ceramic with feldspar glass as a matrix can be manufactured, the resulting glass-ceramic will have greater strength and higher hardness. And by adding other technical means to the microcrystallization process, the glass-ceramic of the feldspar matrix glass becomes transparent glass-ceramic. In the present disclosure, feldspar type matrix glass raw materials are mainly used as hard template materials for microcrystallite precipitation, and the amount of Al₂O₃ used is further increased to improve glass strength. In order to make the glass-ceramic transparent, the particle size of microcrystallites is smaller than the wavelength of visible light (360-950 nm), that is, the particle size of microcrystallites is made to reach a nanometer level, and in order to achieve a higher level of light transmittance, such as visible light transmittance of 90% or more, the particle size of the microcrystallites at the nanometer level should be controlled in the range of 100 nm or below, and it is also necessary to ensure that refractive indexes of a glass base material, nanocrystallites, and a solid solution are basically close to the same, and in order to obtain high strength, the amount of the microcrystallites should reach 50%-95%. The glass-ceramic thus manufactured is transparent nano-glass-ceramic with high strength, high hardness and high transparency.

Based on this, in the present disclosure,
1. by strengthening the content of Al₂O₃ in feldspar type mineral raw materials, an aluminum-rich feldspar type glass ceramic material is synthesized to form a synthetic aluminum-rich feldspar type glass ceramic material with a chemical formula K₂O/Na₂O/Li₂O/CaO/BaOXAl₂O₃YSiO₂, where 1.1≤X≤2.4, and Y=2-6, i.e., alumina powder of which the amount is equivalent to 10%-140% by mass of the Al₂O₃ content in feldspar and the corresponding feldspar raw material synthetic aluminum-rich feldspar are prepared into network framework-like glass, or aluminum-rich feldspar is synthesized by using the corresponding chemical raw materials according to the chemical formula (K₂O/Na₂O/Li₂O/CaO/BaO)XAl₂O₃2SiO₂, and the corresponding synthetic aluminum-rich feldspar is melt into the network framework-like glass to be used as typical hard base glass with good chemical stability;
2. as a preferred example, an aluminum-rich feldspar type ceramic glass material is synthesized: nepheline (crystallized nepheline) intergrown with aluminum-rich kalialbite matrix glass, with small nano-size ultra-fine microcrystallites, and “near-range ordered long-range homogeneous” composite highly transparent glass is constructed, which has a Mohs hardness of 7-8 and a fracture toughness of 5-8 MPa·m^{1/2}.
3. there are also synthetic β-dicalcium silicate microcrystallites of “ring buckle” microcrystallites in the above network framework-like microcrystallite structure space to reinforce a framework-like main crystal phase;
4. in order to prevent glass microcrack propagation under the action of an external force, nano-ZrO₂/Y₂O₃ (a yttria-stabilized zirconia solid solution) and MgAlO₄ stabilized crystal grains of 10 nm or below are introduced for pinning, riveting and toughening to form a toughened solid solution, and nano-ZrO₂ of 10 nm below is uniformly, continuously and densely distributed in a network framework-like glass body as a nucleating agent at the same time, in-situ nucleation growth is performed, nucleation is fast, and the time for crystal nuclei to grow into nano-scale crystals is short, and is easy to control (by controlling the nucleation temperature and time and the crystallization temperature and time, the nanocrystallites are controlled to be 5-30 nm and the amount of the nanocrystallites is controlled to be 50-95%);
5. to improve the thermodynamic stability of the glass-ceramic, a nanocrystallite solid solution formed by β-spodumene and cordierite and/or a nanocrystallite solid solution formed by lithium feldspar and cordierite are introduced, so that the thermal expansion coefficient is small and the thermal shock vibration is alleviated;
6. the introduction of a very small amount of phosphates such as tricalcium phosphate Ca₃(PO₄)₂ and boron phosphate BO₄P into exemplary aluminum-rich kalialbite glass with low network-disrupting R₂O composition effectively activates the migration and flow of molten glass to ensure the material properties (fluidity and forming viscosity) after the molten glass is fined in a temperature field of 1550-1600° C.;
7. The following synthetic materials are used in the present disclosure:
\textcircled{1} Synthetic β-dicalcium silicate material
\textcircled{2} β-spodumene (solid solution) material and cordierite material
\textcircled{3} Composite magnesia-alumina spinel material
\textcircled{4} Synthetic aluminum-rich feldspar type material
\textcircled{5} Yttria-stabilized zirconia material
8. A novel in-situ growth production method of high-strength highly transparent nano-glass-ceramic according to the present disclosure is in-situ production method adopting an alumina-magnesia spinel sagger or an α-corundum-mullite sagger or an α-corundum-quartz glass sagger, and is completely suitable for commercial production of high-end optical glass-ceramic, and multicolor glass-ceramic cover plates;
9. The transparent nano-glass-ceramic of the present disclosure is high-strength highly transparent nano-glass-ceramic with a feldspar type mineral matrix material as a mineral template; 10. In order to achieve chemical strengthening, albite (or nepheline)-containing minerals are used as necessary raw materials for the synthetic aluminum-rich feldspar type ceramic glass material (or synthesized by using precursor chemical raw materials for preparing albite or nepheline), so as to facilitate Na⁺→Li⁺ (replacing lithium with sodium) and K⁺→Na⁺ (replacing sodium with potassium) when the prepared transparent nano-glass-ceramic is subjected to twice staged ion exchange strengthening; 11. To achieve high strength, the following technical means are mainly adopted: (1) basic matrix glass is feldspar-based glass, (2) microcrystallites in the glass-ceramic are nanocrystallites of 100 nm or less, and the amount of the microcrystallites is 50%-95%; (3) reduction of microcracks: the production using a saggar in-situ growth method greatly reduces the amount of bubbles in molten glass after fining, the microcracks are greatly reduced, and at the same time, the microcracks are pinned, riveted and toughened due to the use of nano-ZrO₂/Y₂O₃ and MgAlO₄ spinel-stabilized crystal grains of 10 nm or below, forming a toughened solid solution, which prevents the propagation of microcracks in a glass body, and greatly improves the mechanical strength; (4) synthetic β-dicalcium silicate nanocrystallites having a ring-buckled structure form locked crystals, aluminum-rich feldspar type nanocrystallites with a framework-like long-chain structure are surrounded and interlocked by the synthetic β-dicalcium silicate nanocrystallites, strengthening a continuous space framework-like structure, the surface layer like a carpet-like densely woven structure, and the fracture toughness is greatly improved; (5) Effect of a magnesia-alumina (or composite magnesia-alumina) spinel material on strength; and (6) Chemical strengthening: a surface compressive stress layer generated by ion exchange after strengthening has a depth of 20-120 m. The chemical strengthening is a second step ion exchange strengthening in a way that the primary strengthening is Na⁺→Li⁺ and the secondary strengthening is K⁺→Na⁺, thereby greatly increasing the mechanical strength of the glass-ceramic. 12. To achieve nanocrystallites of 100 nm or below in the nano-glass-ceramic, the following technical means are employed: with zirconia micropowder having a particle size of less than 10 nm as a nucleating agent, to ensure that the zirconia micropowder having a particle size of less than 10 nm is uniformly, continuously and densely dispersed and distributed, and to prevent aggregation of the zirconia micropowder, yttria Y₂O₃ is added as a stabilizer for zirconia, and at the same time, a dispersant is added to prevent agglomeration of the zirconia micropowder having a particle size of less than 10 nm or yttria-stabilized zirconia raw materials having a particle size of 3-10 nm, a graphene oxide dispersant is added in a ratio of zirconia to the graphene oxide dispersant being 1:3 (i.e., the amount of the graphene oxide dispersant is 3 times the amount of zirconia), ball milling and uniform mixing are performed, and the ball-milled material is then added to a glass batch to be ball-milled together and uniformly mixed, so that the zirconia micropowder of less than 10 nm can be dispersed and uniformly distributed in the glass batch without agglomeration. It is ensured that the zirconia micropowder of less than 10 nm is uniformly, continuously and densely distributed and dispersed in a glass raw batch with the synthetic aluminum-rich feldspar type ceramic glass material as a main material, and uniformly, continuously and densely distributed and dispersed crystal nuclei are easily generated in the glass body after melt-forming and annealing; and then, at the temperature of microcrystallite growth, the microcrystallites are controlled to grow into nanocrystallites of 100 nm or below (mainly nanocrystallites of 10-30 nm) by the technical means of controlling the temperature and time of nucleation and crystallization. 13. The nano-glass-ceramic is produced by the sagger in-situ growth method, wherein the sagger adopts a spinel sagger, preferably a magnesia-alumina spinel sagger or an α-corundum-mullite sagger or an a-corundum-quartz glass sagger, further preferably a composite magnesia-alumina spinel sagger to reduce the production cost of the spinel sagger and the cost of one-time use of the spinel sagger.

Non-limiting examples of the present disclosure are provided below.

### Example 1

A high-strength high-transparent nano-glass-ceramic employs precursor mineral materials including a synthetic aluminum-rich feldspar type ceramic glass material, a β-spodumene or β-spodumene solid solution material, a cordierite material, a synthetic β-dicalcium silicate material, and a magnesia-alumina (or composite magnesia-alumina) spinel material as a main body of feldspar type matrix glass with a stable structure, wherein zirconia micropowder with a particle size of less than 10 nm is used as a nucleating agent and a microcrack damping pinning agent to control the formation of nanocrystallites of less than 100 nm in a glass body formed after melting, the nanocrystallites being present in an amount of 50-95% by mass, and being intergrown with the matrix glass to form high-strength highly transparent nano-glass-ceramic with a uniform microstructure.

A chemical formula of the synthetic aluminum-rich feldspar type ceramic glass material is K₂O/Na₂O/Li₂O/CaO/BaOXAl₂O₃YSiO₂, wherein 1.1≤X≤2.4, and Y=2-6, and the synthetic aluminum-rich feldspar type ceramic glass material is expressed as a composite ceramic glass material of one or two or more of a plurality of synthetic aluminum-rich feldspars of synthetic aluminum-rich feldspars of synthetic aluminum-rich kalialbite, synthetic aluminum-rich albite, synthetic aluminum-rich lithium feldspar, synthetic aluminum-rich anorthite, and synthetic aluminum-rich celsian. The composite ceramic glass material of two or more of the plurality of synthetic aluminum-rich feldspars at least include a composite ceramic glass material of the synthetic aluminum-rich albite.

The synthetic aluminum-rich feldspar type ceramic glass material is obtained by preparing the corresponding precursor raw materials containing K₂O/Na₂O/Li₂O/CaO/BaO, Al₂O₃, and SiO₂ into a batch according to a weight percentage ratio of K₂O/Na₂O/Li₂O/CaO/BaO to Al₂O₃ to SiO₂ in a chemical formula K₂O/Na₂O/Li₂O/CaO/BaOXAl₂O₃YSiO₂, grinding the batch, performing sieving with a 300-1000-mesh sieve, and subjecting the obtained dry powder material to sintering thermal synthesis at a firing temperature of 1200-1300° C.

Preferably, according to the chemical formula K₂O/Na₂O/Li₂O/CaO/BaOXAl₂O₃YSiO₂ of the synthetic aluminum-rich feldspar type ceramic glass material, where 1.1≤X≤2.4, and Y=2-6, the corresponding precursor raw materials containing K₂O/Na₂O/Li₂O/CaO/BaO, Al₂O₃, and SiO₂ adopt the corresponding potassium/sodium/lithium/calcium/barium feldspar refined raw materials and added alumina powder of which the amount is equivalent to 10-140% of the Al₂O₃ content in feldspar raw materials in proportion to be prepared into a batch, the batch is pulverized and ground uniformly to 300-1000 meshes, and calcination thermal synthesis is performed; or, corresponding potassium/sodium/lithium/calcium/barium carbonate chemical raw materials are used, i.e., a source of K₂O, Na₂O, Li₂O, CaO, and BaO adopts a carbonate raw material such as potassium carbonate, sodium carbonate, lithium carbonate Li₂CO₃, calcium carbonate, and barium carbonate, an alumina source adopts alumina powder, and a SiO₂ source adopts high-purity quartz powder in the corresponding raw materials containing chemical components K₂O, Na₂O, Li₂O, CaO, BaO, Al₂O₃ and SiO₂ with a desired ratio. The alumina powder is alumina fine powder of 300-1000 meshes, the high-purity quartz powder is high-purity quartz ultrafine powder of 300-1000 meshes, and potassium carbonate, sodium carbonate, lithium carbonate Li₂CO₃, calcium carbonate, and barium carbonate are powders of 300-1000 meshes. The alumina powder of 300-1000 meshes of which the amount is equivalent to 110%-240% of the Al₂O₃ content in the feldspar raw material, and the high-purity quartz powder of 300-1000 meshes are prepared into a batch, the batch is stirred uniformly, and calcination thermal synthesis is performed to obtain the synthetic aluminum-rich feldspar type ceramic glass material.

Thus, according to the chemical formula K₂(/Na₂O/Li₂O/CaO/BaOXAl₂O₃YSiO₂ of the synthetic aluminum-rich feldspar type ceramic glass material, the weight percentages (Wt %) of chemical components K₂O/Na₂O/Li₂O/CaO/BaO, Al₂O₃, and SiO₂ required in a formula of each preparation example in this example are calculated when the content of K₂O/Na₂O/Li₂O/CaO/BaO is different, 1.1≤X≤24=Y=2-6, and values of X and Y are respectively taken, as shown in the following table for details.

TABLE 1
Table of the batch chemical composition for the synthetic
aluminum-rich feldspar type ceramic glass material (wt %)

| Preparation | | | | | | | | Synthetic aluminum-rich feldspar type |
|---|---|---|---|---|---|---|---|---|
| Example No. | K₂O | Na₂O | Li₂O | CaO | BaO | Al₂O₃ | SiO₂ | [R₂O/ROXAl₂O₃YSiO₂] |
| S1 | 1.75 | 10.38 | | | | 20.88 | 66.99 | (K₂O)_{0.1}(Na₂O)_{0.9}XAl₂O₃YSiO₂ |
| | | | | | | | | X = 1.1, Y = 6 |
| S2 | 3.07 | 8.10 | | | | 30 | 58.82 | (K₂O)_{0.2}(Na₂O)_{0.8}XAl₂O₃YSiO₂ |
| | | | | | | | | X = 1.8, Y = 6 |
| S3 | 9.00 | 5.94 | | | | 39.08 | 45.98 | (K₂O)_{0.5}(Na₂O)_{0.5}XAl₂O₃YSiO₂ |
| | | | | | | | | X = 2.0, Y = 4 |
| S4 | | 9.22 | 1.12 | | | 22.75 | 66.91 | (Na₂O)_{0.8}(Li₂O)_{0.2}XAl₂O₃YSiO₂ |
| | | | | | | | | X = 1.2, Y = 6 |
| S5 | | 8.14 | 0.98 | | | 31.80 | 59.07 | (Na₂O)_{0.8}(Li₂O)_{0.2}XAl₂O₃YSiO₂ |
| | | | | | | | | X = 1.9, Y = 6 |
| S6 | | 7.53 | 1.56 | | | 38.90 | 52.01 | (Na₂O)_{0.7}(Li₂O)_{0.3}XAl₂O₃YSiO₂ |
| | | | | | | | | X = 2.2, Y = 5 |
| S7 | | 7.54 | | 6.81 | | 27.29 | 58.37 | (Na₂O)_{0.5}(CaO)_{0.5}XAl₂O₃YSiO₂ |
| | | | | | | | | X = 1.1, Y = 4 |
| S8 | | 9.03 | | 3.49 | | 27.58 | 59.90 | (Na₂O)_{0.7}(CaO)_{0.3}XAl₂O₃YSiO₂ |
| | | | | | | | | X = 1.3, Y = 4.8 |
| S9 | | 13.15 | | 1.32 | | 36.05 | 49.48 | (Na₂O)_{0.9}(CaO)_{0.1}XAl₂O₃YSiO₂ |
| | | | | | | | | X = 1.5, Y = 3.5 |
| S10 | | 12.87 | | | 3.53 | 28.24 | 55.36 | (Na₂O)_{0.9}(BaO)_{0.1}XAl₂O₃YSiO₂ |
| | | | | | | | | X = 1.2, Y = 4 |
| S11 | | 8.18 | | | 8.65 | 28.85 | 54.31 | (Na₂O)_{0.7}(BaO)_{0.3}XAl₂O₃YSiO₂ |
| | | | | | | | | X = 1.5, Y = 4.8 |
| S12 | | 9.83 | | | 6.07 | 22.24 | 61.85 | (Na₂O)_{0.8}(BaO)_{0.2}XAl₂O₃YSiO₂ |
| | | | | | | | | X = 1.1, Y = 5.2 |
| S13 | | 9.44 | | | | 35.73 | 54.83 | Na₂OXAl₂O₃YSiO₂ |
| | | | | | | | | X = 2.3, Y = 6 Synthetic aluminum-rich |
| | | | | | | | | albite |
| S14 | | 10.24 | | | | 30.32 | 59.44 | Na₂OXAl₂O₃YSiO₂ |
| | | | | | | | | X = 1.8, Y = 6 Synthetic aluminum-rich |
| | | | | | | | | albite |
| S15 | 7.65 | 15.15 | | | | 33.22 | 43.97 | K₂O3NaO4Al₂O₃9SiO₂ |
| | | | | | | | | Synthetic nepheline |
| S16 | 3.10 | 7.94 | 0.66 | | | 22.40 | 65.90 | (K₂O)_{0.18}(Na₂O)_{0.7}(Li₂O)_{0.12}XAl₂O₃YSiO₂ |
| | | | | | | | | X = 1.2, Y = 6 |
| S17 | 0.64 | 7.71 | 2.85 | | | 34.57 | 54.23 | (K₂O)_{0.03}(Na₂O)_{0.55}(Li₂O)_{0.42}XAl₂O₃YSiO₂ |
| | | | | | | | | X = 1.5, Y = 4 |

In Table 1, 17 Preparation examples of the synthetic aluminum-rich feldspar type ceramic glass material are given. A raw material batch is prepared according to the above chemical composition ratio, then the raw material batch is ground at a high speed, and dry powder uniformly passing through a 200-mesh sieve is loaded into a sealed sagger with a lid and fired in a kiln, so that the required synthetic aluminum-rich feldspar type ceramic glass material is synthesized by a sintering method.

Preferably, when the synthetic aluminum-rich feldspar type ceramic glass material contains both K₂O and Li₂O, the content of K₂O+Li₂O is 24 (the content in synthetic aluminum-rich feldspar, see Preparation examples S16 and S17 in Table 1), and K₂O:Li₂O=4-5:1 or 1:4-5, forming a mixed alkali effect, which is beneficial for reducing the glass melting temperature and improving the chemical stability.

Preferably, when the synthetic aluminum-rich feldspar type ceramic glass material is an aluminum-rich albite (see Preparation examples S13-S14 in Table 1) or synthetic nepheline (see Preparation example S15 in Table 1) ceramic glass material of Na₂OXAl₂O₃₂SiO₂, 0.2-0.5% o niobium oxide Nb₂O₅ is also added to the raw materials in order to improve strength and acid and alkali resistance. Natural nepheline has a large content of mineral impurities, which is not conducive to manufacturing high-end glass such as optical glass and high-strength glass. By preparing the corresponding raw material formula according to its chemical formula, synthetic nepheline is prepared to obtain high-purity synthetic mineral raw materials, which are high-aluminum (aluminum-rich) synthetic mineral raw materials.

Preferably, the synthetic β-dicalcium silicate material is a stable synthetic β-dicalcium silicate material, i.e., β-Ca₂SiO₄ or β-2CaO·SiO₂ obtained by determining the amount of limestone or calcite or calcium oxide and quartz used in synthetic raw materials according to a theoretical weight ratio of CaO to SiO₂ in a molecular formula CaOSiO₂ of wollastonite, uniformly mixing the two raw materials, performing firing at a firing temperature of 1320-1360° C. to obtain synthetic wollastonite, i.e., CaSiO₃, grinding the synthetic CaSiO₃ and a mineralizer B₂O₃ with an amount being 0.5-1.5% of the moles of CaSiO₃ together into a powder, and performing firing at 1280-1320° C.

Preferably, the raw materials used further include yttria Y₂O₃ as a stabilizer for the zirconia micropowder in an amount of zirconia:yttria=90-95:5-10, or yttria-stabilized zirconia raw material micropowder (having the same ratio of zirconia:yttria=90-95:5-10) is used directly instead of the zirconia micropowder to obtain stable zirconia-containing micropowder. The yttria-stabilized zirconia raw materials can be commercially available raw materials. To prevent agglomeration of the zirconia micropowder having a particle size of less than 10 nm or yttria-stabilized zirconia raw materials of 3-10 nm, a graphene oxide dispersant is added in a ratio of zirconia to the graphene oxide dispersant being 1:3 (i.e., the amount of the graphene oxide dispersant is 3 times the amount of zirconia), ball milling is performed, and the ball-milled material is then added to a glass batch to be ball-milled together, so that the zirconia micropowder of less than 10 nm can be dispersed and uniformly distributed in the glass batch without agglomeration.

Preferably, the raw materials used also include 0-5% by mass a network-enhancing raw material boron phosphate BO₄P, so that a P₂O₅ component can be introduced. Boron phosphate BO₄P can use a commercially available raw material.

Preferably, the raw materials also include phosphates: the phosphates used are calcium zirconium phosphate [CaZr(PO₄)₂] and calcium phosphate [Ca₃(PO₄)₂], the content of CaZr(PO₄)₂+Ca₃(PO₄)₂ being 0-5%, CaZr(PO₄)₂:Ca₃(PO₄)₂=5:1-2:1, thereby improving stability and strength. Calcium zirconium phosphate [CaZr(PO₄)₂] is a synthetic raw material, and is prepared by reacting zirconium hydrogen phosphate Zr(HPO₄)₂H₂O with calcium oxide CaO.

Preferably, the raw materials used may also include zinc borate ZB which has the effect of limiting the growth of microcrystallites in multiple measures to ensure that the microcrystallites are nanocrystallites.

Preferably, the β-spodumene raw material or the β-spodumene solid solution is synthesized by sintering at a firing temperature of 1300-1390° C. by using LiCO₃ as a Li₂O source, alumina powder as an alumina source and high-purity quartz powder as a SiO₂ source in precursor raw materials according to a theoretical mass ratio of Li₂O to Al₂O₃ to SiO₂ in a chemical formula Li₂OAl₂O₃nSiO₂ of β-spodumene, where n=4-8 (0-spodumene when n=4, and the β-spodumene solid solution when 4<n≤8), or β-spodumene can directly use spodumene concentrate powder calcined at 1300° C.; and
the cordierite material is synthesized by sintering at 1300-1350° C. by using talc concentrate powder (calcined at 1300° C.) or a MgO analytically pure chemical raw material as a MgO source, alumina powder as an alumina source, and high-purity quartz powder as a SiO₂ source in precursor raw materials according to a theoretical mass ratio of MgO to Al₂O₃ to SiO₂ in a chemical formula 2MgO2Al₂O₃5SiO₂ of cordierite.

Thus, according to the above description, (mineral) raw materials used for manufacturing the matrix glass of the high-strength highly transparent nano-glass-ceramic of the present disclosure include the synthetic aluminum-rich feldspar type ceramic glass material, the β-spodumene material, the cordierite material, the β-dicalcium silicate material, the (composite) magnesia-alumina spinel material, the alumina powder, the high-purity quartz powder, the zirconia micropowder having a particle size of less than 10 nm as the nucleating agent and yttria Y₂O₃ as a stabilizer for the zirconia micropowder or a yttria-stabilized zirconia raw material, and calcium zirconium phosphate [CaZr(PO₄)₂] and calcium phosphate, a glass network-reinforcing raw material boron phosphate, and a fining agent for glass melting, and the contents by mass of raw material components are as follows in Table 2.

TABLE 2

| | |
|---|---|
| Synthetic aluminum-rich feldspar type | 54-80% |
| ceramic glass material | |
| β-spodumene material | 3-30% |
| Cordierite material | 1-6% |
| Synthetic β-dicalcium silicate material | 5-20% |
| (Composite) magnesia-alumina spinel | 2-10% |
| material | |
| Zirconia micropowder having a particle | 1%-6% (additionally adding |
| size of less than 10 nm | 0.05-0.6% a yttria stabilizer, |
| | or directly using yttria- |
| | stabilized zirconia with a |
| | particle size of less than |
| | 10 nm) |
| High-purity quartz powder | 5-20% |
| Calcium zirconium phosphate CaZr(PO₄)₂ | 0-5% |
| and calcium | |
| Boron phosphate | 0-5% |
| Fining agent for glass melting | 0.5-2% |

Preferably, a chemical composition of the high-strength highly transparent nano-glass-ceramic includes in percentage by mass:
6-14% K₂O+Na₂O+BaO;
0.2-3% Li₂O;
20-36% Al₂O₃;
40-69% SiO₂;
2-10% CaO;
1-6% ZrO₂; and
2-10% MgO.

The fining agent for glass melting can adopt Sb₂O₅, the β-dicalcium silicate material can adopt the synthetic β-dicalcium silicate material (a β-dicalcium silicate material prepared by a method in Chinese Patent No: ZL201310374914.X), β-spodumene can be prepared from precursor raw material by a synthesis method in Chinese Patent No: ZL 202011586411.5 (n=4 or a β-spodumene solid solution when n>4), and the cordierite raw material can adopt precursor raw materials for producing cordierite, and according to the theoretical mass ratio of MgO to Al₂O₃ to SiO₂ in the chemical formula 2MgO2Al₂O₃5SiO₂ of cordierite, the talc concentrate powder is used as the MgO source, the alumina powder is used as the alumina source, and the high-purity quartz powder is used as the SiO₂ source, and thermal synthesis is performed at 1300° C. CaZr(PO₄)₂:Ca₃(PO₄)₂=5:1-2:1.

A raw material batch formula of (mineral) raw materials used in 17 Preparation examples for preparing the matrix glass listed in Table 3 below is obtained according to the 17 Preparation examples for preparing the synthetic aluminum-rich feldspar type ceramic glass material in this example listed in Table 1 and the range of (mineral) raw material components for manufacturing the matrix glass of the high-strength highly transparent nano-glass-ceramic of the present disclosure:

TABLE 3
Table of the raw material batch formula in Preparation examples of the matrix glass of the glass-ceramic in the example (wt %)

| | | | | | | | | Calcium | | |
|---|---|---|---|---|---|---|---|---|---|---|
| | | | | | | | | zirconium | | |
| | Aluminum- | | | | Composite | High- | | phosphate | | |
| | rich feldspar | | | β- | magnesia- | purity | | and | | |
| Preparation | type ceramic | β- | | dicalcium | alumina | quartz | Zirconia + | calcium | Boron | Fining |
| example No. | glass | spodumene | Cordierite | silicate | spinel | powder | Yttria | phosphate | phosphate | agent |
| 1 | S1: 55 | 4.5 | 1 | 12 | 10 | 9 | 2 | 0.5 | 5 | 1 |
| 2 | S2: 60 | 10 | 2 | 8 | 4 | 9 | 3 | 2 | 1.0 | 1 |
| 3 | S3: 80 | 3 | 1 | 6 | 2 | 5 | 1.9 | 0.5 | 0.1 | 0.5 |
| 4 | S4: 70 | 10 | 4 | 5 | 3 | 6 | 1 | 0 | 0 | 1 |
| 5 | S5: 60 | 8 | 2 | 9 | 3 | 10 | 3 | 1.7 | 1.8 | 1.5 |
| 6 | S6: 75 | 4 | 1 | 6 | 2 | 8 | 2 | 0 | 0.5 | 1.5 |
| 7 | S7: 55 | 20 | 5 | 7 | 5 | 5 | 1.5 | 1 | 0 | 0.5 |
| 8 | S8: 60 | 9 | 2 | 15 | 4 | 5 | 1.5 | 1 | 1 | 1.5 |
| 9 | S9: 75 | 3 | 1 | 6 | 2 | 11 | 1 | 0 | 0 | 1 |
| 10 | S 10: 55 | 6 | 1 | 6 | 9 | 15 | 2 | 3 | 2 | 1 |
| 11 | S11: 80 | 3 | 1 | 6 | 2 | 5 | 1 | 0.5 | 0.5 | 1 |
| 12 | S12: 75 | 4 | 1.5 | 6.5 | 2 | 7 | 1.5 | 0.7 | 0.8 | 1 |
| 13 | S 13: 55 | 3 | 2 | 20 | 5 | 5 | 3.2 | 4 | 2 | 0.8 |
| 14 | S14: 60 | 10 | 6 | 4 | 6 | 5 | 4.9 | 0.6 | 1.5 | 2 |
| 15 | S15: 60 | 3 | 1 | 6 | 2 | 20 | 5.5 | 0.8 | 0.5 | 1.2 |
| 16 | S16: 60 | 13 | 2 | 7 | 3 | 6 | 2.2 | 5 | 0.6 | 1.2 |
| 17 | S 17: 55 | 29 | 1 | 6 | 2 | 5 | 1 | 0 | 0 | 1 |

In Table 3: S1: 55 in Preparation example 1 in indicates that 55% the synthetic aluminum-rich feldspar type ceramic glass material in Preparation example S1 for preparing the synthetic aluminum-rich feldspar type ceramic glass material in Table 1 is used, and this meaning is similar in other Preparation examples; the amount of zirconia+yttria used is zirconia:yttria=95:5, or yttria-stabilized zirconia raw material micropowder is directly used, and yttria Y₂O₃ is used as a stabilizer for zirconia; and Sb₂O₅ is used as a fining agent, and boron phosphate is BO₄P, which is a commercially available raw material.

The matrix glass obtained by melting the raw material batch formula of the matrix glass of the glass-ceramic according to the examples of Table 3 is subjected to thermodynamic nanocrystallization treatment to obtain nanocrystallites of less than 100 nm generated in the glass body, wherein the mass percentage content of the nanocrystallites is 50-95%.

Preferably, the nanocrystallites include aluminum-rich feldspar type nanocrystallites, β-spodumene nanocrystallites or β-spodumene solid solution nanocrystallites, cordierite nanocrystallites, β-dicalcium silicate nanocrystallites, magnesia-alumina (or composite magnesia-alumina) spinel nanocrystallites, mullite nanocrystallites (an aluminum-rich part forms mullite with part of SiO₂ and quartz in the corresponding feldspar), and zirconia (or yttria-stabilized zirconia solid solution) nanocrystallites. Referring to an X-ray diffraction pattern of the nano-glass-ceramic obtained by crystallization of the matrix glass obtained from the raw material formula of Preparation example 15 in Table 3 in Example 1 shown in the accompanying FIGURE, a main crystal phase of diffraction peaks shown in the FIGURE includes the aluminum-rich feldspar type nepheline nanocrystallites, and a secondary crystal phase includes mullite microcrystallites, the β-dicalcium silicate microcrystallites, and the zirconia (or yttria-stabilized zirconia solid solution) nanocrystallites, and crystal particles of other minerals do not show prominent diffraction peaks due to their relatively low content in this Preparation example 15.

Further preferably, the contents by volume of the respective nanocrystallites in the total nanocrystallites are as follows:
Aluminum-rich feldspar type nanocrystallites, i.e., K₂O/Na₂O/Li₂O/CaO/BaOXAl₂O₃YSiO₂ nanocrystallites 50%-80%, where 1.1≤X≤2.4, and Y=2-6;
β-spodumene nanocrystallites, i.e., β-Li₂OAl₂O₃4SiO₂ nanocrystallites 3-28%;
Cordierite nanocrystallites, i.e., 2MgO2Al₂O₃5SiO₂ nanocrystallites 1-6%;
Synthetic β-dicalcium silicate nanocrystallites, i.e., β-2CaO·SiO₂ nanocrystallites 6-20%;
Magnesia-alumina (or composite magnesia-alumina) spinel nanocrystallites 2-10%; and
Mullite nanocrystallites 5-20%.

The aluminum-rich feldspar type nanocrystallites include one or two or more mixed nanocrystallites of aluminum-rich potassium feldspar nanocrystallites, aluminum-rich albite nanocrystallites (including nepheline nanocrystallites), aluminum-rich lithium feldspar nanocrystallites, aluminum-rich anorthite nanocrystallites, and aluminum-rich celsian nanocrystallites, forming a framework-like long-chain structure in the nano-glass-ceramic, and the β-dicalcium silicate nanocrystallites are of ring buckles with a ring structure, so that one or more long-chain structured aluminum-rich feldspar type nanocrystallites are surrounded and buckled by the β-dicalcium silicate nanocrystallites to form locked crystals, and the locked crystals are also surrounded and buckled by the β-dicalcium silicate nanocrystallites through the long-chain structured aluminum-rich feldspar type nanocrystallites to form a three-dimensional locked crystal space structure, reinforcing the framework-like main crystal phase, and the zirconia nanocrystallites pin and rivet glass microcracks, greatly improving the fracture toughness.

Preferably, the content of K₂O+Na₂O+BaO is 6-14%, wherein:

when the aluminum-rich feldspar type nanocrystallites are mainly aluminum-rich potassium feldspar nanocrystallites,
the content of K₂O is 4%-9%, the content of Na₂O is 2%-7%, and the content of BaO is 0-2%;
when the aluminum-rich feldspar type nanocrystallites are mainly aluminum-rich albite nanocrystallites,
the content of K₂O is 0.85%-4%, the content of Na₂O is 6%-12%, and the content of BaO is 0%-1%;
when the aluminum-rich feldspar type nanocrystallites contain aluminum-rich celsian nanocrystallites,
the content of BaO is 2%-6%, the content of K₂O is 0.85%-2%, and the content of Na₂O is 6%-10%;
further preferably, when the aluminum-rich feldspar type nanocrystallites further contain aluminum-rich lithium feldspar nanocrystallites,
the content of Li₂O is 2%-5%, the content of Na₂O is 6%-9%, the content of K₂O is 0.85%-3%, and the content of BaO is 0%-2%; and
when the aluminum-rich feldspar type nanocrystallites further contain aluminum-rich anorthite nanocrystallites,
the content of CaO is 2%-5%, the content of Na₂O is 6%-9%, the content of K₂G is 0.85%-3%, and the content of BaO is 0-2%.

Preferably, the magnesia-alumina spinel raw material includes synthetic composite magnesia-alumina spinel.

Further preferably, the synthetic composite magnesia-alumina spinel includes different metal oxides in addition to magnesia-alumina spinel, the different metal oxides and alumina respectively form composite spinel crystal structures at a synthesis temperature, the different metal oxides include calcium oxide and barium oxide, and calcium aluminate spinel and barium aluminate spinel, and one or two or more of these spinels can be respectively formed, including at least composite magnesia-alumina spinel formed by compounding the barium aluminate spinel (which is advantageous to reduce the synthesis temperature of spinel formation, reducing the synthesis temperature to 1260-1360° C.) with the magnesia-alumina spinel.

The raw materials used also include 0.5-2% Sb₂O₅ as a fining agent.

The glass-ceramic obtained above is the high-strength highly transparent nano-glass-ceramic.

Preferably, the high-strength highly transparent nano-glass-ceramic is subjected to primary or secondary chemical strengthening, so that the Mohs hardness of the high-strength highly transparent nano-glass-ceramic reaches 8.0-9.0, the fracture toughness of the high-strength highly transparent nano-glass-ceramic is 10-12 MPa·m^{1/2}, the light transmittance of the high-strength highly transparent nano-glass-ceramic is 91%-96%, and the ring-on-ring strength of the high-strength highly transparent nano-glass-ceramic is 3200-5600 MPa after strengthening (a glass sheet has a thickness of 0.4-0.6 mm).

### Example 2

This example provides a method for manufacturing high-strength highly transparent nano-glass-ceramic.

To manufacture the high-strength highly transparent nano-glass-ceramic, required synthetic raw materials are first prepared according to Example 1, including a synthetic aluminum-rich feldspar type ceramic glass material, a β-spodumene material, a cordierite material, a p-dicalcium silicate material and a (composite) magnesia-alumina spinel material, then a raw batch of matrix glass is prepared according to the formula in Preparation examples of Table 3 in Example 1, melting, forming, and microcrystallite nucleation are performed, crystal nuclei grow into nanocrystallites, and annealing is performed to obtain the high-strength highly transparent nano-glass-ceramic.

Therefore, the method for preparing the high-strength highly transparent nano-glass-ceramic includes:
1. Preparation of synthetic raw materials: the required synthetic raw materials are prepared first, a desired type of aluminum-rich feldspar type ceramic glass material is synthesized according to the batch chemical composition table and the raw material ratio for the synthetic aluminum-rich feldspar type ceramic glass material in Table 1 of Example 1, that is, the corresponding precursor raw materials containing K₂O/Na₂O/Li₂O/CaO/BaO, Al₂O₃, and SiO2 adopt the corresponding potassium/sodium/lithium/calcium/barium feldspar raw materials and added alumina powder of which the amount is equivalent to 10-140% of the Al₂O₃ content in the feldspar raw materials in proportion to be prepared into a batch, the batch is pulverized and ground uniformly to 300-1000 meshes, and calcination thermal synthesis is performed; or, corresponding potassium/sodium/lithium/calcium/barium carbonate chemical raw materials are used, i.e., a source of K₂O, Na₂O, Li₂O, CaO, and BaO adopts a carbonate raw material such as potassium carbonate, sodium carbonate, lithium carbonate Li₂CO₃, calcium carbonate, and barium carbonate, an alumina source adopts alumina powder, and a SiO₂ source adopts high-purity quartz powder in the corresponding raw materials containing chemical components K₂O, Na₂O, Li₂O, CaO, BaO, Al₂O₃ and SiO₂ with a desired ratio. The alumina powder is alumina fine powder of 300-1000 meshes, the high-purity quartz powder is high-purity quartz ultrafine powder of 1000-2000 meshes, and potassium carbonate, sodium carbonate, lithium carbonate Li₂CO₃, calcium carbonate, and barium carbonate are powders of 300-1000 meshes. The alumina powder of 300-1000 meshes of which the amount is equivalent to 110%-240% of the Al₂O₃ content in the feldspar raw material, and the high-purity quartz powder of 1000-2000 meshes are prepared into a batch, the batch is stirred uniformly, and calcination thermal synthesis is performed to obtain a synthetic mineral raw material of the synthetic aluminum-rich feldspar type ceramic glass material. Taking the aluminum-rich albite (feldspar type) ceramic glass material Na₂OXAl₂O₃6SiO₂ (X=1.8) in Preparation example S14 in Table 1 as an example: alumina powder of which the amount is equivalent to 80% by weight of the amount of alumina in the albite is added into 1 part by weight of refined albite powder, the mixture is pulverized and ground uniformly to 600-mesh, and calcination thermal synthesis is performed at 1300° C. to obtain a synthetic mineral material of the aluminum-rich albite ceramic glass material.

According to the weight percentage ratio of Na₂O to Al₂O₃ to SiO₂ in the chemical formula Na₂OXAl₂O₃6SiO₂ (X=1.8) of the aluminum-rich albite ceramic glass material in Preparation example S14, a carbonate raw material sodium carbonate of 400 meshes, alumina fine powder of 1000 meshes, and high-purity quartz powder of 1000 meshes are respectively used to be prepared into a batch, the batch is uniformly stirred, and calcination thermal synthesis is performed at 1100° C. to obtain a synthetic mineral material Na₂O1.8Al₂O₃6SiO₂ of the synthetic aluminum-rich albite ceramic glass material.

The β-spodumene raw material may be synthesized by preparing a batch by using precursor raw materials for corresponding oxide sources, respectively according to oxides Li₂O, Al₂O₃, SiO₂ in the chemical formula (Li₂OAl₂O₃nSiO₂, n=4-8) of the β-spodumene raw material, performing uniform stirring, and performing calcination thermal synthesis, for example, β-spodumene (n=4) or β-spodumene solid solution (4<n≤8) is prepared by the synthesis method in Chinese Patent No.: ZL 20202011586411.5, and the β-spodumene raw material can also directly use spodumene concentrate powder calcined at 1300° C.; and
the cordierite raw material may be a commercially available raw material, or may be obtained by preparing a batch by using precursor raw materials for corresponding oxide sources, respectively according to oxides Al₂O₃, SiO₂, and MgO in the chemical formula 2MgO2Al₂O₃5SiO₂ of the cordierite raw material, performing uniform stirring, and performing calcination thermal synthesis at 1350° C.

The β-dicalcium silicate β-2CaO·SiO₂ material is prepared by the synthesis method in Chinese patent No.: ZL201310374914.X, that is, firstly, the amount of limestone or calcite and quartz in the synthetic raw materials are determined according to the theoretical weight ratio of CaO to SiO₂ in the molecular formula CaOSiO₂ of wollastonite, and after the two raw materials are mixed uniformly, the mixture is fired at a firing temperature of 1320-1360° C. to obtain synthetic CaSiO₃, that is, wollastonite; the synthetic CaSiO₃ and a mineralizer B₂O₃ with an amount being 0.5-1.5% of the moles of CaSiO₃ are ground together into a powder, and the resulting stable (3-Ca₂SiO₄ is fired at 1280-1320° C. to obtain β-dicalcium silicate β-2CaO·SiO₂.

The composite magnesia-alumina spinel material is prepared by the synthesis method described in Chinese Patent Publication CN114907110B or Chinese Application Publication CN119707475A. That is, the composite magnesia-alumina spinel material of calcium oxide/barium oxide/magnesium oxide can be synthesized. The composite magnesia-alumina spinel material in this example adopts a ratio of 0.34CaO 0.58MgO 0.06BaO 0.56Al₂O₃, CaO adopts calcined limestone, MgO adopts light-burned magnesium powder or magnesia, and BaO adopts barium oxide powder, and raw materials in the formula are pulverized to 200-360 meshes, mixed uniformly, and calcined, and sintered at a firing temperature of 1200-1300° C. for 12 h to obtain a synthetic composite magnesia-alumina spinel material (CaOMgOBaO)Al₂O₃.

Synthesis of calcium zirconium phosphate: calcium zirconium phosphate [CaZr(PO₄)₂] is a synthetic raw material, and is prepared by reacting zirconium hydrogen phosphate Zr(HPO₄)₂H₂O with calcium oxide CaO.
2. Formula batching: the synthetic raw materials are batched with other raw materials according to the formula ratio requirements, namely batching is carried out according to the raw material batch formula in Preparation examples of the matrix glass of the glass-ceramic in Table 3 in Example 1, and by taking the raw material batch formula in Preparation example 14 in Table 3 as an example, 600% the aluminum-rich albite (feldspar type) ceramic glass raw material prepared in the preparation of the synthetic raw materials, 10% β-spodumene, 5% cordierite, 5% β-dicalcium silicate (β-Ca₂SiO₄), 5% high-purity quartz powder, 6% magnesia-alumina composite spinel, 4.5% zirconia micropowder having a particle size of less than 10 nm (additionally adding 0.4% yttria as a zirconia stabilizer), 0.6% calcium zirconium phosphate and calcium phosphate (CaZr(PO₄)₂:Ca₃(PO₄)₂=2:1, i.e., 0.4% calcium zirconium phosphate, and 0.2% calcium phosphate), 1.5% boron phosphate, and 2% the fining agent Sb₂O₅ are batched. The chemical composition of the raw materials in the formula is shown in Table 4 below.

TABLE 4
The chemical composition table of the raw materials used in the present disclosure (wt %)

| | | | | | | | | | | | |
|---|---|---|---|---|---|---|---|---|---|---|---|
| SiO₂ | AI₂O₃ | K₂O | Na₂O | MgO | CaO | P₂O₅ | Li₂O | B₂O₃ | ZrO₂ | BaO | Nb₂O₅ |

The chemical composition of raw materials for the synthetic aluminum-rich
feldspar type ceramic glass material is detailed in Table 1 of Example 1

| β- | 64.52 | 27.42 | | | | | 8.06 | | | | |
|---|---|---|---|---|---|---|---|---|---|---|---|
| spodumene | | | | | | | | | | | |
| Cordierite | 51.37 | 34.93 | | | 13.70 | | | | | | |
| Alumina | | 99.9 | | | | | | | | | |
| powder | | | | | | | | | | | |
| Zirconia | | | | | | | | | 99.9 | | |
| powder | | | | | | | | | | | |
| β- | 34.68 | | | | | 64.72 | | 0.6 | | | |
| dicalcium | | | | | | | | | | | |
| silicate | | | | | | | | | | | |
| High- | 99.99 | | | | | | | | | | |
| purity | | | | | | | | | | | |
| quartz | | | | | | | | | | | |
| powder | | | | | | | | | | | |
| Lithium | CO₂ | | | | | | 40.46 | | | | |
| carbonate | 59.54 | | | | | | | | | | |
| Potassium | CO₂ | | 64.4 | | | | | | | | |
| carbonate | 35.6 | | | | | | | | | | |
| Sodium | CO₂ | | | 48.5 | | | | | | | |
| carbonate | 51.5 | | | | | | | | | | |
| Calcined | 68 | | | | 32 | | | | | | |
| talc | | | | | | | | | | | |
| Zinc | ZnO | | | | | | | 45 | | | H₂O |
| borate | 37.5 | | | | | | | | | | 13.5 |
| Calcium | CaZr(PO₄)₂ | | | | | | | | | | |
| zirconium | 99 | | | | | | | | | | |
| phosphate | | | | | | | | | | | |
| Calcium | Ca₃(PO₄)₂ | | | | | | | | | | |
| phosphate | 99 | | | | | | | | | | |
| Boron | BO₄P | | | | | | | | | | H₂O |
| phosphate | 99 | | | | | | | | | | 1 |
| Yttria | Y₂O₃ | | | | | | | | | | |
| | 99.9 | | | | | | | | | | |
| Niobium | | | | | | | | | | | 99.9 |
| oxide | | | | | | | | | | | |
| Composite | | 52.63 | | | 21.37 | 17.54 | | | | 8.46 | |
| magnesia- | A chemical formula of spinel in this example is: | | | | | | | | | | |
| alumina | 0.34CaO 0.58MgO 0.06BaO 0.56Al₂O₃ | | | | | | | | | | |
| spinel | | | | | | | | | | | |

3. Processing and mixing: raw materials of the batch are pulverized to a desired particle size 200-300 meshes, and the pulverized materials are uniformly mixed to obtain a dry powder glass raw batch;
4. Melt forming: the dry powder glass raw batch is added into a glass melting device, melting, fining, and homogenizing are performed, and forming is performed by adopting an appropriate forming method according to the product requirements;
The glass has a melting temperature of 1500-1600° C. and a fining temperature of 1550-1600° C. According to different raw material batch formulae in Preparation examples of the matrix glass of the glass-ceramic in Table 3 of Example 1, the melting temperature and fining temperature of the matrix glass are different. This example takes Preparation example 14 in Table 3 as an example. The melting includes heating the dry powder batch to 1500-1600° C., and performing melting for 2-4 hours, and fining is performed at 1550-1600° C. for 3-5 hours.

Preferably, in the melt forming described in this example, the melting includes adding the dry powder batch into a sagger for melting glass, and placing the sagger in a high temperature furnace for melting, fining, and homogenizing;
Further preferably, the sagger is a magnesia-alumina spinel sagger; further preferably, the magnesia-alumina spinel sagger is a synthetic composite magnesia-alumina spinel sagger; and further preferably, a synthetic composite magnesia-alumina spinel sagger described in Chinese patent No.: ZL202210579939.2, i.e., a composite magnesia-alumina spinel sagger prepared by the synthesis method in Chinese patent No.: ZL202210579939.2 is used.

Or, this example may also adopt another glass melting method, the melting in the melt forming includes adding the dry powder batch to a furnace for melting glass for melting, fining, and homogenizing.

The forming adopting the appropriate forming method according to the product requirements include a horizontal sheet process, a calendering method, a tape casting method, an overflow method, and a sagger in-situ forming method. The sagger in-situ forming method includes melting the green raw batch in a sagger, and performing in-situ forming in the sagger directly through the shape of the sagger, which is a basis of a microcrystallite nucleation in-situ growth method after subsequent annealing. The forming method used in this example is selected from the sagger in-situ forming method, the tape casting method, and the overflow method according to the product requirements.
5. Nucleation and crystallization: the formed glass product is heated to a nucleation temperature, nucleation is performed, crystallization is then performed by controlling the temperature and time to control the growth of grains into nanocrystallites to obtain a high-strength highly transparent nano-glass-ceramic product.

Preferably, the formed product is subjected to nucleation and crystallization, the nucleation is performed at a temperature of 600-650° C. for 2-4 h, and the crystallization is performed at a temperature of 650-700° C. for 2-6 h.

According to the raw material batch formula in Preparation examples of the matrix glass of the glass-ceramic in Table 3 of Example 1, taking Preparation example 14 in Table 3 as an example, the thermodynamic treatment of nucleation and crystallization of the obtained matrix glass is performed by using a temperature regime as follows: the formed glass product is nucleated and crystallized, and has a temperature of about 700° C., and
(1) cooling is performed from 700° C. to 650° C. at a cooling rate of 0.5° C./min, heat preservation is performed at 650° C. for 2 hours, and nucleation is performed; and
(2) heating is performed from 650° C. to 700° C. at a heating rate of 0.5° C./min, heat preservation is performed at 700° C. for 2-5 hours, and crystallization is performed.
6. Annealing: the crystallized product is annealed to eliminate a thermal stress in a glass body to obtain a high-strength highly transparent nano-glass-ceramic product.

The annealing temperature regime is as follows: the crystallized product is heated from room temperature to 600-650° C. at a heating rate of 0.4-1.0° C./min, the temperature is maintained at 600-650° C. for 2-5 hours, annealing is performed, and cooling is performed from the holding temperature during annealing to room temperature at a cooling rate of 0.2-0.5° C./min.

According to different raw material batch formulae in Preparation examples of the matrix glass of the glass-ceramic in Table 3 of Example 1, the specific operation of the annealing temperature regime of the resulting matrix glass is different, this example is still exemplified by Preparation example 14, and the annealing temperature regime of the resulting matrix glass is as follows: the formed product is cooled from 700° C. to 650° C. at a cooling rate of 0.5° C./min after maintaining the temperature at 700° C. for 2 hours, and annealing is performed while maintaining the temperature at 650° C. for 3-5 hours; and then cooing is performed from the holding temperature during annealing 650° C. to room temperature at a cooling rate of 0.4° C./min (which is a once annealing mode).

Preferably, before the nucleation and crystallization, the formed glass product can also be pre-annealed first, and a pre-annealing process includes first heating the glass product to 650-700° C., performing heat preservation for 2-5 h, then reducing the temperature to 550-600° C. at 0.2-0.3° C./min, performing the pre-annealing while maintaining the temperature for 2-3 h, then reducing the temperature to 500° C. at 0.2-0.3° C./min, performing heat preservation for 2-3 h, and then raising the temperature to the nucleation temperature at no more than 0.5° C./min for the subsequent nucleation and crystallization and annealing (which is a twice annealing mode).

Further preferably, for matrix glass formation using the sagger in-situ forming method, the annealing and nucleation and crystallization adopt an in-situ growth method, i.e., the glass is formed directly through the shape of the sagger, and the matrix glass in the sagger together with the sagger is directly placed in a crystallization furnace for nucleation and crystallization, and then annealed in an annealing kiln to obtain the transparent nano-glass-ceramic. The modes of nucleation and crystallization and annealing thermal treatment may be a once annealing mode or a twice annealing mode as described above. The temperature regime of the nucleation and crystallization and annealing heat treatment is the same as described above.

Further preferably, the transparent nano-glass-ceramic obtained through nucleation and crystallization by the in-situ growth method is segmented from the sagger, then subjected to further forming and processing to obtain a desired structure, and then subjected to strengthening treatment. After the sagger is segmented, cut sagger waste and glass waste are recycled.

Preferably, after the transparent nano-glass-ceramic is obtained, the method further includes: performing further forming and processing on the transparent nano-glass-ceramic product to obtain a desired structure, followed by strengthening treatment. As described above in this example, the nano-glass-ceramic is segmented from the sagger to obtain glass ingots (or glass ingots are formed from molten glass coming out of the glass furnace, and nucleated, crystallized and annealed to obtain transparent nano-glass-ceramic ingots), and the glass ingots are cut into a panel (or a back panel) glass sheet for cell phones with a thickness of 0.2-0.5 mm by a diamond wire cutting machine. To further increase strength, the nano-glass-ceramic product is strengthened. The strengthening includes physical strengthening or chemical strengthening.

The chemical strengthening is once chemical strengthening or multiple chemical strengthening, and a surface compressive stress layer generated by ion exchange after strengthening has a depth of 20-120 μm.

The multiple chemical strengthening is twice staged ion exchange strengthening in such a way that primary strengthening is Na⁺→Li⁺ and secondary strengthening is K⁺→Na⁺, thereby greatly improving the mechanical strength of the glass-ceramic.

The highly transparent nano-glass-ceramic in Preparation example 14 of this example is subjected to once chemical strengthening, namely, the highly transparent nano-glass-ceramic is placed in a mixed salt bath of 15 wt % NaNO₃ and 85 wt % KNO₃ for strengthening ion exchange at an ion exchange temperature of 420° C. for 8 hours. The depth of a compressive stress layer generated by Na⁺→Li⁺ exchange is tested to be 30-90 μm.

Secondary strengthening is K⁺→Na⁺, with an ion exchange temperature of 500° C. and an exchange time of 12 hours. The depth of a compressive stress layer generated by K⁺→Na⁺ exchange is tested to be 20-50 μm.

The high-strength highly transparent nano-glass-ceramic of the present disclosure is tested to achieve the following technical performance indexes.

Drop resistance test at a specified height: a glass sheet is not broken when vertically dropped from a height of 2-2.6 meters; for example, a strengthened glass sheet with a length and a width of 5×5 cm and a thickness of 0.5 mm is not broken when vertically dropped from a height of 2.5 meters.

Fracture toughness: 5-8 MPa·m^{1/2} before strengthening, 10-12 MPa·m^{1/2} after strengthening, and after strengthening, the deeper the depth of the ion exchange layer (the thicker the thickness), the higher the fracture toughness.

Hardness: Mohs hardness before strengthening is 7-8, and Mohs hardness after strengthening is 8-9.

The ring-on-ring strength after strengthening is 3200-5000 MPa (a glass sheet has a thickness of 0.4-0.6 mm).

A chemically strengthened compressive stress layer has a thickness of 20-120 am.

Coefficient of thermal expansion: 1.5×10⁻⁶/° C.-5.2×10⁻⁶/° C., softening point: 850-930° C. (viscosity η=1.5×10⁹-3.5×10⁹ poise), annealing point: 630-680° C. (viscosity η=1.0×10¹³-2.5×10¹³ poise), and strain point: 580-620° C. (viscosity η=1.0×10¹⁴. poise).

Optical properties: 1. Refractive index: 1.51-1.53; 2. 91%<visible light transmittance≤96%; and 3. Haze: <0.1%.

Mechanical properties include: 1. a Poisson's ratio of 0.21-0.23; 2. a Young's modulus of 11.5-14.1 Mpsi after strengthening; 3. Vickers hardness of 720 kgf/mm² or more before strengthening, and Vickers hardness of 780 kgf/mm² more after strengthening; and 4. flexural strength of more than 550 MPa before strengthening, and flexural strength of more than 850 MPa after strengthening.

Particle size of nanocrystallites: mainly composed of nanocrystallites of 5-30 nm (the largest particle size of the remaining nanocrystallites is less than 100 nm). The nanocrystallites have a particle size of about 5-30 nm and are connected to each other like densely woven carpets, which also illustrates why the high-strength highly transparent nano-glass-ceramic has high fracture toughness.

Nanocrystallite type: the nanocrystallites include aluminum-rich feldspar type nanocrystallites, β-spodumene nanocrystallites, cordierite nanocrystallites, synthetic β-dicalcium silicate nanocrystallites, mullite nanocrystallites, magnesia-alumina/composite magnesia-alumina spinel nanocrystallites, zirconia/yttria solid solution nanocrystallites, and diopside nanocrystallites.

Total content of nanocrystallites: 50%-95%. The nanocrystallites mainly in the range of 5-30 nm are connected to each other like densely woven carpets, and the nanocrystallites are densely distributed. Through testing the glass in 17 Preparation examples listed in Table 3 in the Example, the microcrystallite content is 50%-95%, and the nanocrystallites are intergrown with residual matrix glass to form high-strength highly transparent nano-glass-ceramic with a uniform microstructure.

Tyndall effect Test: when a beam of visible red light passes through a glass-ceramic sheet in a direction perpendicular to a thickness plane, it can be seen that a very bright red light beam, i.e., Tyndall effect light beam, passes horizontally through a flat panel of the glass, indicating that there are microcrystallites with a diameter d of 1-100 nm in the glass-ceramic, and the particle size of the nanocrystallites is smaller than the wavelength of incident light (the visible light has a wavelength of about 360-700 nm). Thus, a significant scattering effect occurs when the visible light passes through the glass-ceramic. The intensity of scattered light increases with the increase of the concentration of nanocrystallite particles in a dispersion system. The stronger the scattered light, which demonstrates that the particle size of the nanocrystallites is greater than 1 nm (5-30 nm), resulting in scattering, the higher the proportion of the nanocrystallites (50%-95%).

### Example 3

This example provides application of high-strength highly transparent nano-glass-ceramic.

The high-strength highly transparent nano-glass-ceramic of the present disclosure is applied to manufacture cell phone covers or back covers: due to high surface hardness, a cell phone panel manufactured from the nano-glass-ceramic is good in abrasion resistance, has a surface that is not easily scratched or foggy, and is high in fracture toughness, high in bending strength, and high in light transmittance, and can be made into 3D panel glass, and the nano-glass-ceramic can also be applied to manufacture a cell phone back panel, has no shielding property for radio waves, facilitates arbitrary arrangement of a cell phone antenna inside the cell phone, and receives and emits signals without being affected by the panel and the back panel.

The nano-glass-ceramic is applied to manufacture optical glass: due to the synergistic effect of various nanocrystallites, the strength of the glass-ceramic is improved, and at the same time, the refractive index of various nanocrystallites is relatively close to the refractive index of residual glass, the light transmittance is high, and thus, the use requirements of optical glass can be achieved, including high hardness, abrasion resistance, no fogging, and no mold. Therefore, the nano-glass-ceramic is used for cameras, glass lenses for glasses, viewing windows and housings for high-end instruments and equipment, etc.

The nano-glass-ceramic can also be applied to manufacture cover glass for high-end electronic products, windshield and side window glass for high-speed trains and aviation aircraft, vehicle-mounted control panels, and quantum radar panels.

What is claimed is:

1. High-strength highly transparent nano-glass-ceramic, wherein precursor mineral materials comprise a synthetic aluminum-rich feldspar type ceramic glass material, a β-spodumene or β-spodumene solid solution material, a cordierite material, a synthetic β-dicalcium silicate material, and a magnesia-alumina spinel material is employed as a main body of feldspar type matrix glass with a stable structure, zirconia micropowder with a particle size of less than 10 nm is used as a nucleating agent and a microcrack damping pinning agent to control the formation of nanocrystallites of less than 100 nm in a glass body formed after melting, the nanocrystallites is present in an amount of 50-95% by volume, and is intergrown with the matrix glass to form high-strength highly transparent nano-glass-ceramic with a uniform microstructure.

2. The high-strength highly transparent nano-glass-ceramic according to claim 1, wherein a chemical formula of the synthetic aluminum-rich feldspar type ceramic glass material is K₂O/Na₂O/Li₂O/CaO/BaOXAl₂O₃YSiO₂, wherein 1.1≤X≤2.4, and Y=2-6, and the synthetic aluminum-rich feldspar type ceramic glass material is expressed as a composite ceramic glass material of one or two or more of a plurality of synthetic aluminum-rich feldspars of synthetic aluminum-rich potassium feldspar, synthetic aluminum-rich albite, synthetic aluminum-rich kalialbite, synthetic aluminum-rich lithium feldspar, synthetic aluminum-rich anorthite, and synthetic aluminum-rich celsian, and
wherein the composite ceramic glass material of two or more of the plurality of synthetic aluminum-rich feldspars at least comprises a composite ceramic glass material of the synthetic aluminum-rich albite.

3. The high-strength highly transparent nano-glass-ceramic according to claim 1, wherein the synthetic β-dicalcium silicate material is a stable synthetic β-dicalcium silicate material, i.e., β-Ca₂SiO₄, obtained by determining the amount of limestone or calcite or calcium oxide and quartz used in synthetic raw materials according to a theoretical weight ratio of CaO to SiO₂ in a molecular formula CaOSiO₂ of wollastonite, uniformly mixing the two raw materials, performing firing at a firing temperature of 1320-1360° C. to obtain synthetic wollastonite, i.e., CaSiO₃, grinding the synthetic CaSiO₃ and a mineralizer B₂O₃ with an amount being 0.5-1.5% of the moles of CaSiO₃ together into a powder, and performing firing at 1280-1320° C.;
the β-spodumene or β-spodumene solid solution material is synthesized by sintering at a firing temperature of 1300-1390° C. by using LiCO₃ as a Li₂O source, alumina powder as an alumina source and high-purity quartz powder as a SiO₂ source according to a theoretical mass ratio of Li₂O to Al₂O₃ to SiO₂ in a chemical formula Li₂OAl₂O₃nSiO₂ of β-spodumene or the β-spodumene solid solution, wherein n=4-8, or β-spodumene is obtained by directly calcining spodumene concentrate powder at 1300° C.;
the cordierite material is synthesized by sintering at 1300-1400° C. by using talc concentrate powder or a MgO analytically pure chemical raw material as a MgO source, alumina powder as an alumina source, and high-purity quartz powder as a SiO₂ source according to a theoretical mass ratio of MgO to Al₂O₃ to SiO₂ in a chemical formula 2MgO2Al₂O₃5SiO₂ of cordierite;
the magnesia-alumina spinel raw material comprises synthetic composite magnesia-alumina spinel; and
the synthetic composite magnesia-alumina spinel comprises different metal oxides in addition to magnesia-alumina spinel, the different metal oxides and alumina respectively form composite spinel crystal structures at a synthesis temperature, the different metal oxides comprise calcium oxide and barium oxide, and calcium aluminate spinel and barium aluminate spinel, and one or two or more of these spinels are respectively formed, comprising at least composite magnesia-alumina spinel formed by compounding the barium aluminate spinel with the magnesia-alumina spinel.

4. The high-strength highly transparent nano-glass-ceramic according to claim 2, wherein the high-strength highly transparent nano-glass-ceramic uses mineral raw materials as the main body, and further comprises quartz and a fining agent for glass melting, and comprises the following raw material components in percentage by mass:
54-80% of a synthetic aluminum-rich feldspar type ceramic glass material;
3-30% of a β-spodumene material or a β-spodumene solid solution;
1-6% of a cordierite material;
5-20% of synthetic β-dicalcium silicate;
2-10% of a magnesia-alumina spinel material;
1-6% of zirconia micropowder having a particle size of less than 10 nm;
5-20% of high-purity quartz powder; and
0.5-2% of a fining agent for glass melting.

5. The high-strength highly transparent nano-glass-ceramic according to claim 4, wherein a chemical composition of the high-strength highly transparent nano-glass-ceramic comprises in percentage by mass:
6-14% of K₂O+Na₂O+BaO;
0.2-3% of Li₂O;
20-36% of Al₂O₃;
40-69% of SiO₂;
2-10% of CaO;
1-6% of ZrO₂; and
2-10% of MgO.

6. The high-strength highly transparent nano-glass-ceramic according to claim 2, wherein according to the chemical formula R₂O/ROXAl₂O₃YSiO₂ of the synthetic aluminum-rich feldspar type ceramic glass material, wherein 1.1≤X≤2.4, and Y=2-6; when R₂O is K₂O/Na₂O/Li₂O, Y≤6; when RO is CaO/BaO, Y≥2; and when having feldspars corresponding to R₂O/RO at the same time, Y=2-6; the corresponding potassium/sodium/lithium/calcium/barium feldspar refined raw materials and added alumina powder of which the amount is equivalent to 10-140% of the Al₂O₃ content in feldspar raw materials are used in proportion to be prepared into a batch, the batch is pulverized and ground uniformly to 300-1000 meshes, and calcination thermal synthesis is performed; or corresponding potassium/sodium/lithium/calcium/barium carbonate chemical raw materials, alumina powder of 300-1000 meshes of which the amount is equivalent to 110-240% of the Al₂O₃ content in feldspar raw materials, and high-purity quartz powder of 300-1000 meshes are used in proportion to be prepared into a batch, the batch is stirred uniformly, and calcination thermal synthesis is performed to obtain the synthetic aluminum-rich feldspar type glass ceramic material.

7. The high-strength highly transparent nano-glass-ceramic according to claim 2, wherein when the synthetic aluminum-rich feldspar type ceramic glass material comprises both K₂O and Li₂O, a content of K₂O+Li₂O is 2-6%, and K₂O:Li₂O=4-5:1 or 1:4-5; and
when the synthetic aluminum-rich feldspar type ceramic glass material is an albite aluminum-rich feldspar type ceramic glass material of Na₂OXAl₂O₃6SiO₂, 0.2-0.5% rare earth or rare metal oxides that are non-coloring in the glass are further comprised to improve a strength.

8. The high-strength highly transparent nano-glass-ceramic according to claim 4, wherein the raw materials used further comprise yttria Y₂O₃ as a stabilizer of the zirconia micropowder in an amount of zirconia:yttria=90-95:5-10, or yttria-stabilized zirconia raw material micropowder is directly used instead of the zirconia micropowder.

9. The high-strength highly transparent nano-glass-ceramic according to claim 1, wherein the raw materials used further comprise 0.1-2% by mass a network-reinforcing raw material boron phosphate to introduce a P₂O₅ component; and
wherein the raw materials further comprise phosphates: the phosphates used are calcium zirconium phosphate CaZr(PO₄)₂ and calcium phosphate Ca₃(PO₄)₂, the content of CaZr(PO₄)₂+Ca₃(PO₄)₂ is 0.1-2%, and CaZr(PO₄)₂:Ca₃(PO₄)₂=5:1-2:1.

10. The high-strength highly transparent nano-glass-ceramic according to claim 5, wherein the nanocrystallites comprise aluminum-rich feldspar type nanocrystallites, β-spodumene or β-spodumene solid solution nanocrystallites, cordierite nanocrystallites, synthetic β-dicalcium silicate nanocrystallites, magnesia-alumina spinel nanocrystallites, mullite nanocrystallites, and zirconia or zirconia/yttria solid solution nanocrystallites;
the contents by volume of the respective nanocrystallites in the total nanocrystallites are as follows:
50-80% of Aluminum-rich feldspar type nanocrystallites, i.e., K₂O/Na₂O/Li₂O/CaO/BaOXAl₂O₃YSiO₂ nanocrystallites, wherein 1.1≤X≤2.4, and Y=2-6;
3-28% of β-spodumene or β-spodumene solid solution nanocrystallites;
1-6% of Cordierite nanocrystallites;
5-20% of Synthetic β-dicalcium silicate nanocrystallites;
2-10% of Magnesia-alumina spinel nanocrystallites;
5-20% of Mullite nanocrystallites; and
1-6% of Zirconia or zirconia/yttria solid solution nanocrystallites; and
the aluminum-rich feldspar type nanocrystallites comprise one or two or more mixed nanocrystallites of aluminum-rich potassium feldspar nanocrystallites, aluminum-rich albite nanocrystallites, aluminum-rich lithium feldspar nanocrystallites, aluminum-rich anorthite nanocrystallites, and aluminum-rich celsian nanocrystallites, forming a framework-like long-chain structure in the nano-glass-ceramic, and the synthetic β-dicalcium silicate nanocrystallites β-2CaO·SiO₂ are of ring buckles with a ring structure, so that one or more long-chain structured aluminum-rich feldspar type nanocrystallites are surrounded and buckled by the β-dicalcium silicate nanocrystallites to form locked crystals, and the locked crystals are also surrounded and buckled by the β-2CaO·SiO₂ nanocrystallites through the long-chain structured aluminum-rich feldspar type nanocrystallites to form a three-dimensional locked crystal space structure, reinforcing a framework-like main crystal phase, and the zirconia nanocrystallites or zirconia/yttria solid solution nanocrystallites pin and rivet glass microcracks.

11. The high-strength highly transparent nano-glass-ceramic according to claim 10, wherein a content of K₂O+Na₂O+BaO is 6-14%, wherein:
when the aluminum-rich feldspar type nanocrystallites are mainly the aluminum-rich potassium feldspar nanocrystallites, a content of K₂O is 4-9%, a content of Na₂O is 2-7%, and a content of BaO is 0-2%;
when the aluminum-rich feldspar type nanocrystallites are mainly the aluminum-rich albite nanocrystallites, the content of K₂O is 0.854%, the content of Na₂O is 6-12%, and the content of BaO is 0-1%; and
when the aluminum-rich feldspar type nanocrystallites comprise the aluminum-rich celsian nanocrystallites, the content of BaO is 2-6%, the content of K₂O is 0.85-2%, and the content of Na₂O is 6-10%.

12. The high-strength highly transparent nano-glass-ceramic according to claim 10, wherein when the aluminum-rich feldspar type nanocrystallites further comprises the aluminum-rich lithium feldspar nanocrystallites, a content of Li₂O is 2-5%, the content of Na₂O is 6-9%, the content of K₂O is 0.85-3%, and the content of BaO is 0-2%; and
when the aluminum-rich feldspar type nanocrystallites further comprises the aluminum-rich anorthite nanocrystallites, the content of CaO is 2-5%, the content of Na₂O is 6-9%, the content of K₂O is 0.85-3%, and the content of BaO is 0-2%.

13. The high-strength highly transparent nano-glass-ceramic according to claim 1, wherein the high-strength highly transparent nano-glass-ceramic is subjected to primary or secondary chemical strengthening, a Mohs hardness is 6.0-8.0 before strengthening, and is 7.0-9.0 after strengthening, a fracture toughness is 4.8-8 MPa·m^{1/2} before strengthening, and is 10-12 MPa·m^{1/2} after strengthening, a light transmittance is 91%-96%, and a ring-on-ring strength is 3200-5600 MPa after strengthening.

14. A method for preparing high-strength highly transparent nano-glass-ceramic, comprising:
preparation of synthetic raw materials: carrying out synthesis according to a proportion of synthetic raw materials in the high-strength highly transparent nano-glass-ceramic according to claim 1 to obtain corresponding synthetic mineral materials;
formula batching: batching the synthetic raw materials with other raw materials according to formula ratio requirements;
processing and mixing: pulverizing raw materials of a batch to a desired fineness, and uniformly mixing the pulverized materials to obtain a dry powder glass raw batch;
melt forming: adding the dry powder batch into a glass melting device, performing melting, fining, and homogenizing, and performing forming by adopting an appropriate forming method according to product requirements;
nucleation and crystallization: nucleating the formed glass product at a nucleation temperature, and then performing crystallization by controlling a temperature and time to control growth of grains into nanocrystallites with a desired fineness and amount; and
annealing: annealing the crystallized product to eliminate a thermal stress in a glass body to obtain a high-strength highly transparent nano-glass-ceramic product.

15. The method for preparing the high-strength highly transparent nano-glass-ceramic according to claim 14, further comprising: performing further forming and processing on the nano-glass-ceramic product to obtain a desired structure, followed by strengthening treatment;
wherein strengthening the nano-glass-ceramic product comprises physical strengthening or chemical strengthening;
the chemical strengthening is once chemical strengthening or twice chemical strengthening, and a surface compressive stress layer generated by ion exchange after strengthening has a depth of 20-120 m; and
the twice chemical strengthening is twice staged ion exchange strengthening in such a way that primary strengthening is Na⁺→Li⁺ and secondary strengthening is K⁺→Na⁺.

16. The method for preparing the high-strength highly transparent nano-glass-ceramic according to claim 14, wherein adding the dry powder batch into the glass melting device during the melt forming comprises adding the dry powder batch to a sagger for melting glass, and placing the sagger in a high temperature furnace for melting, fining, and homogenizing in an oxidizing atmosphere or an oxidizing-reducing atmosphere;
the sagger is a magnesia-alumina spinel sagger or an α-corundum-mullite sagger or an a-corundum-quartz glass sagger;
the magnesia-alumina spinel sagger is a synthetic composite magnesia-alumina spinel sagger;
the nucleation and crystallization adopt an in-situ growth method, i.e., the glass is formed directly in situ through the shape of the sagger, and the glass in the sagger together with the sagger is directly nucleated and crystallized in a kiln, and then annealed to obtain the transparent nano-glass-ceramic; and
the transparent nano-glass-ceramic obtained through nucleation and crystallization by the in-situ growth method is segmented from the sagger, then subjected to further forming and processing to obtain a desired structure, and then subjected to strengthening treatment.

17. The method for preparing the high-strength highly transparent nano-glass-ceramic according to claim 14, wherein during the melt forming, melting comprises adding the dry powder batch into a furnace for melting glass for melting, fining, and homogenizing, and forming is carried out by tape casting, or calendering, or overflow forming; and
the melting temperature is 1500-1600° C. and the fining temperature is 1550-1600° C.

18. The method for preparing the high-strength highly transparent nano-glass-ceramic according to claim 14, wherein the formed product is subjected to nucleation and crystallization, the nucleation is performed at a temperature of 600-650° C. for 2-4 h, and the crystallization is performed at a temperature of 650-750° C. for 2-6 h; and
before the nucleation and crystallization, the formed glass product is first pre-annealed, and a pre-annealing process comprises first heating the glass product to 650-750° C., performing heat preservation for 2-5 h, then reducing the temperature to 550-600° C. at 0.2-0.3° C./min, performing the pre-annealing while maintaining the temperature for 2-3 h, then reducing the temperature to 500° C. at 0.2-0.3° C./min, performing heat preservation for 2-3 h, and then raising the temperature to the nucleation temperature at no more than 0.5° C./min for a subsequent nucleation and crystallization and annealing.

19. The method for preparing the high-strength highly transparent nano-glass-ceramic according to claim 14, wherein the annealing is performed at a temperature of 500-550° C., a heating rate is 0.5-1° C./min, the holding time during annealing is 1-4 h, and cooling is performed from the holding temperature during annealing to room temperature at a cooling rate of 0.2-0.4° C./min.

20. Application of high-strength highly transparent nano-glass-ceramic, wherein the high-strength highly transparent nano-glass-ceramic according to claim 1 is applied to manufacture various types of optical glass, comprising cell phone covers and back covers, cameras, cover glass for high-end electronic products, windshield and side window glass for high-speed trains and aviation aircraft, viewing window glass and housings for high-end instruments and equipment, vehicle-mounted control panels, and quantum radar panels.
